(19) United States
(12) Patent Application Publication
(10) Pub. No.: US 2023/0147264 A1
(43) Pub. Date: May 11, 2023

(54) METHOD AND DEVICE FOR RECOVERING METAL

(71) Applicant: 3R-CYCLE OY, Hyvinkää (FI)

(72) Inventor: Tero RINNE, Vaasa (FI)

(21) Appl. No.: 17/918,435

(22) PCT Filed: Apr. 27, 2021
(86) PCT No.: PCT/FI2021/050311

§ 371 Date: Oct. 12, 2022

(30) Foreign Application Priority Data
Apr. 28, 2020 (FI) 20205424

(51) Int. Cl. C22B 3/04; C25B 11/043; C25B 9/17; C22B 3/24; C25B 1/30; C25B 9/15

(52) U.S. Cl. CPC C22B 3/045; C25B 11/043; C25B 9/17; C22B 3/24; C25B 1/30; C25B 9/15

(57) ABSTRACT

The present application provides a method for recovering metal from metal-containing material by leaching, the method comprising providing aqueous solution containing leaching agent precursor, providing one or more source(s) of external energy comprising a source of electric current connected to one or more non-metallic electrode(s) comprising carbon material(s) selected from graphite, graphene and derivatives thereof, and carbon nanomaterial(s) selected from carbon nanofibers, carbon nanotubes and carbon nanobuds, treating the aqueous solution with the external energy, which is electric current providing electrochemical reactions, to form hydrogen peroxide from oxygen in the aqueous solution, reacting the leaching agent precursor with the formed hydrogen peroxide to form a leaching agent and to obtain a leaching solution, providing metal-containing material, reacting the metal-containing material with the leaching solution to obtain soluble metal complexes, and recovering the soluble metal complexes. The present application also discloses a device for recovering metal from metal-containing material by leaching.

### FIELD OF THE APPLICATION

The present application relates to a method and device for recovering metal from metal-containing material by leaching using external energy. More particularly the method relates to production of hydrogen peroxide by treating aqueous solution by the external energy.

### BACKGROUND

It is desired to treat metal-containing materials, such as waste materials or ore, to recover precious metals from the material. Such recovery methods include leaching techniques, wherein metals are solubilized from the material using a leaching solution and recovered from the solution.

However, many materials used in leaching contain toxic or harmful substances, which are not desired for environmental and safety reasons. The leaching techniques also involve use of several chemicals and controlling the reaction conditions using other chemicals, which make the process complex, slow, challenging and expensive. It is desired to obtain simpler and environmentally safer metal recovery methods which can be controlled, and which use less chemicals and/or energy. It is also desired to obtain methods and devices which can be easily controlled.

### SUMMARY

In the present invention it was found out that it was possible to obtain a simple leaching method and device for recovering metals from metal-containing materials, wherein the process could be implemented by providing external non-chemical energy to the process, for example by using electrochemical reactions, such as electrolysis/electrosynthesis, ultrasound, plasma and/or laser. In such method fewer or no additional chemical agents are required and the process can be controlled and maintained with less additional reagents. The process can be also controlled electronically, which enables fast and accurate control of the reactions, also automation of the control. This results in an efficient and safe method wherein inexpensive and safe agents can be used. The use of hazardous chemicals, such as cyanide materials or strong acids, for example sulfuric acid or nitrohydrochloric acid, can be avoided.

The present application provides a method for recovering metal from metal-containing material by leaching, the method comprising
providing aqueous solution containing leaching agent precursor,
providing one or more source(s) of external energy comprising a source of electric current connected to one or more non-metallic electrode(s) comprising carbon material(s) and/or derivatives thereof selected from graphite, graphene, and carbon nanomaterial(s) selected from carbon nanofibers, carbon nanotubes and carbon nanobuds,
treating the aqueous solution with the external energy, which is electric current providing electrochemical reactions,
to form hydrogen peroxide from oxygen in the aqueous solution, preferably by electrochemical oxygen reduction,
reacting the leaching agent precursor with the formed hydrogen peroxide to form a leaching agent and to obtain a leaching solution,
providing metal-containing material,
reacting the metal-containing material with the leaching solution to obtain soluble metal complexes, and
recovering the soluble metal complexes.

The present application also provides a device for recovering metal from metal-containing material by leaching, the device comprising
a reactor 11 arranged to receive metal-containing material and aqueous solution,
one or more source(s) of external energy 10 arranged to provide external energy to the aqueous solution 14 in the reactor 11, the source of external energy comprising one or more non-metallic electrode(s) 20 comprising carbon material(s) and/or derivatives thereof selected from graphite, graphene, and carbon nanomaterial(s) selected from carbon nanofibers, carbon nanotubes and carbon nanobuds, connected or arranged to be connected to a source of electric current to provide electrochemical reactions, preferably to obtain electrochemical oxygen reduction reaction, to form hydrogen peroxide,
a measuring device 17 arranged to measure one or more reaction product(s) obtained to the aqueous solution by using the external energy,
a control unit 13 operatively connected to the one or more sources of external energy and to the measuring device 17, the control unit 13 being, as a feedback to the measurement, arranged to adjust the one or more source(s) of external energy to obtain a desired level of reactions, such as the electrochemical oxygen reduction reactions, in the aqueous solution, and preferably
means for recovering metal complexes from the solution.

The main embodiments are characterized in the independent claims. Various embodiments are disclosed in the dependent claims. The embodiments and examples recited in the claims and the specification are mutually freely combinable unless otherwise explicitly stated. Examples which are not in the scope of the claims may be considered as examples useful for understanding the invention.

When the reactive species, especially hydrogen peroxide, are generated by providing external energy to the aqueous solution in situ and on site it is possible to obtain for example radicals, redox pairs and/or hydrogen peroxide without adding any highly reactive reagents, which may be harmful or expensive. By using the methods disclosed herein it is possible to obtain these reaction products more efficiently than with conventional methods. This also simplifies the method as it is not necessary to purchase, transport, store, handle and/or control the dosing of such reagents. This is cost efficient, as the logistic expenses related to transport of chemicals can be minimized. For example hydrogen peroxide, when transported in conventional way as about 30% solution, increases the costs and as a strong oxidant requires careful control in the sense of safety.

Hydrogen peroxide (H₂O₂) is considered a green oxidant, and it is relatively non-toxic and breaks down in the environment to non-toxic by-products. It is also desired to produce hydrogen peroxide with environmentally friendly methods, preferably in situ or on site. The conventionally used anthraquinone autoxidation provides considerable amounts of toxic organic waste and it needs to be run at large plants to compensate for the high operating costs. The present methods can overcome these problems.

It may be desired to utilize oxygen reduction reactions (ORR) wherein oxygen is combined with water and electrons, such as two or four electrons, to produce hydrogen peroxide in a synthesis obtained electrochemically. To obtain such a reaction it is necessary to provide suitable reaction conditions to efficiently and selectivity guide the reactions toward oxygen reduction and reduce overpotential. This may be obtained by using specific materials that catalyze the ORR selectively, such as by using carbon-based electrodes or other materials. By utilizing ORR it is possible to avoid using harmful organic solvents but use green solvents and reagents instead, such as water, ethanol or methanol. It is desired to drive the reactions towards direct formation of hydrogen peroxide and suppress or avoid redox reactions producing water, hydrogen or O₂. Increased energy efficiency may be obtained. Hydrogen peroxide can be produced by a simple and economic process with a simple system, such as a system using a single reactor. An industrially applicable selective and stable process can be obtained. There is no need to maintain H₂ and O₂ outside the explosive regime. The present methods and materials provide a safe, simple and inexpensive alternative to the presently used route involving hydrogenation of an anthraquinone and O₂ oxidation of the resulting dihydroanthraquinone.

Leaching agent(s) may be generated from a simple and inexpensive starting material, such as potassium iodide, by using only or mainly the external energy. It is also possible to control and optimize the reaction conditions and the equilibrium of the reactions and concentrations of formed reagents, especially by controlling the source of the external energy. For example, it is possible to control the activation of desired reaction(s), such as optimal formation of oxidant(s), solvent(s), or other reagents to remove or enhance removing of metals of interest or other desired substances from the processed raw materials.

Especially it is possible to control the oxidation of leaching agents or precursors thereof, such as thiourea or halide-based agents, by using controlled electrosynthesis of hydrogen peroxide. Hydrogen peroxide itself may also act as a leaching agent or support the leaching process. Therefore the consumption of the leaching agent or leaching agent precursor can be controlled and limited, which is economic and safe. The leaching potential can be maintained at an optimal range. In case of thiourea for example it is possible to avoid such overreaction where the thiourea is converted (oxidized) into a form which cannot be restored, in which case active chemical should be added more to the reaction. At the worst scenario such an excess oxidation would lead to formation of harmful substances such as cyanamide, elemental sulphur and hydrogen sulphide, which may be formed for example when unstable formamidine disulphide obtained from thiourea is decomposed at pHs over 3. Therefore it is important to be able to control the oxidation, especially the level of oxidizing agents. In the conventional reactions utilizing thiourea the lifespan of useful thiourea is relatively short, so with the present methods it is possible to maintain the process active for a prolonged time, even without addition of chemicals during the process.

In the present methods it is possible to use green technology involving organic chemicals, such as hydrogen peroxide and organic acids, and/or green electricity, such as by using solar or wind power as a source of electricity.

It was specially found out that specific non-metallic electrodes, such as 3D porous carbonaceous electrodes, BDD electrodes and electrodes comprising carbon nanomaterials, such as carbon nanotube (B, N, BDD, Fe doped) materials such as porous boron-doped diamond/carbon nanotube electrodes, work well at acidic environment to achieve leaching solution at low overpotential, thus for example minimizing formation of harmful decomposition of thiourea, and also increased corrosion resistance for non-metallic doped catalysts used as electrode materials.

It is possible to obtain fully electronic control of the process, as the source of external energy, such as power level, onset period, frequency and other parameters of the source of energy, can be controlled electronically and/or automatically, for example as feedback to parameters measured or determined directly from the solution, reaction or reactor. As the process can be efficiently controlled, the cost-efficiency is increased. The response to controlling actions is very fast, as the source of energy is directly controlled. A real time control over the process may be obtained. This is a great benefit for example compared to controlling actions based on chemical addition, temperature adjustment and the like.

It is also possible to use the source of external energy for providing protons and/or hydroxyl ions from water, which ions may be used for adjusting the pH of the solution. Also this simplifies the process, as there is no need to provide separate pH adjusting agents and devices for dosing such agents. It is possible to adjust the pH automatically.

With the present method it is possible to recycle and/or regenerate the used reagents efficiently, preferably back to the process, without additional activating reagents.

It is also possible to use specific scavenger materials for recovering the solubilized metals. Controlling the reactions by adjusting the source(s) of external energy enable maintaining the reaction conditions in such state that facilitate the recovery step, for example avoiding excess concentrations of reagents or other chemicals in the solution, which could interfere the recovery process or materials. By using specific surface-treated or surface-activated scavenger materials it is possible to recover specifically precious metals such as gold, which may be present in low concentrations, from leaching solution without using further reagents to for example adjust the pH or other conditions of the solution. This further simplifies the process and makes it more selective, more safe and environmentally friendly.

In general, compared to other leaching methods and systems utilizing external energy, it is possible to lower the need of external energy by using the reactions and devices disclosed herein for the leaching process as well as for the recovery process. For example by using specific catalytic materials and/or scavenger materials it is possible to use less powerful devices or use less electricity. It is also possible to enhance the formation of leaching agent by using catalytic electrodes, such as formation of triiodide from potassium iodide.

### BRIEF DESCRIPTION OF THE FIGURES

FIG. 1 shows an example of a reactor setup

FIG. 2 shows an example of a reactor setup comprising two electrodes connected to a source of electric current as one source of external energy and another source of further energy, such as a source of ultrasound

FIG. 3 shows a detailed example of a device setup having several reactors

### DETAILED DESCRIPTION

In this specification, percentage values, unless specifically indicated otherwise, are based on weight (w/w). If any numerical ranges are provided, the ranges include also the upper and lower values. The open term “comprise” also includes a closed term “consisting of” as one option.

Leaching refers to the loss or extraction of certain materials from a carrier into a liquid. More particularly, leaching as discussed herein refers to a process wherein the metal of interest, such as precious metal, platinum group metal or rare earth metal, is soluble. Impurities may be insoluble. The metal or rare earth metal may be present in mixtures with very large amounts of undesirable constituents, and leaching is used to remove the metals or rare earth metals as soluble salts which may be also called metal complexes. The term “metal complex” refers to any suitable soluble metal compound of a metal of interest which is obtained in the process. The starting material, such as ore or waste, may be called as substrate. The substrate is treated with aqueous leach solution to produce a “pregnant solution”, which contains the leached metal or rare earth metal of interest in a soluble form. The metal or rare earth metal can be recovered from the pregnant solution using any suitable methods.

The leaching solution, or lixiviant, is an aqueous solution which, when in contact with the substrate, solubilizes at least a portion of the metal of interest in the substrate by oxidizing the metal. This process may be carried out in a pH range 1-10, but in many cases a pH in the range of 4-7 may be used. If acid is added, the pH may be lower, such as in the range of 0-4, 0-3, 0-2, 1-4 or 1-3. The leaching solution contains one or more leaching agent(s). The leaching solution may be formed in the container or reactor also containing the metal-containing material, or the leaching solution may be formed in a separate container or reactor and then combined with the metal-containing material. The pH wherein the reactions are carried out may have an impact to the leaching pH, and the pH or pH range wherein these reactions are carried out may be the same, or it may be different. The pH of the aqueous solution may be adjusted with a pH adjusting agent, such as acid, or by any other suitable method. The pH adjusting agent may be added in an amount required to obtain a desired pH or a pH in a desired range. It is also possible to add other additives, such as one or more buffering agent(s), one or more electrolyte(s) or conductive agent(s) such as sodium sulphite or sodium chloride, one or more stabilizing agent(s) such as (dihydrogen) sodium phosphate and/or the like.

The present application provides a method for recovering metal from metal-containing material by leaching. The metal-containing material may be any suitable material which includes one or more desired metal(s) in material composition containing also materials which are not desired to recover. Rare earth metals, also called as rare earth elements, are included in the term “metal” herein. The embodiments and examples referring to “metals” are also applicable to rare earth metals. Such metal-containing or rare earth metal containing material may comprise ore, jewellery, or waste materials, such as electronic waste. The ore may be ore from mining industry, such as ore concentrate.

Electronic waste may include material from electronic devices, cables and connectors, such as circuit boards, electronic components, coated cables or connectors, and the like. For example circuit boards or connectors may have a gold coating, which is desired to be recovered and separated from the other materials, such as from other metals, for example copper or iron. The waste material may contain complete electronic compounds, circuit boards, connectors, cables or the like, or the material may be provided in crushed or pulverized form, and/or otherwise preprocessed, such as by using heat and/or chemicals. Crushed or pulverized material may be provided as an aqueous suspension, which may be conveyed to and/or in a device in a liquid flow. The jewellery may contain scrap gold, crap silver or other scrap precious metals.

The metal to be recovered may be any desired metal, such as a precious metal or platinum group metal. The metal may be for example gold, silver, platinum, palladium, but it may be also refer to copper, zinc, iron, rare earth metals and the like. The rare earth metals may include cerium (Ce), dysprosium (Dy), erbium (Er), europium (Eu), gadolinium (Gd), holmium (Ho), lanthanum (La), lutetium (Lu), neodymium (Nd), praseodymium (Pr), promethium (Pm), samarium (Sm), scandium (Sc), terbium (Tb), thulium (Tm), ytterbium (Yb), and/or yttrium (Y). Platinum group metals include ruthenium (Ru), rhodium (Rh), palladium (Pd), osmium (Os), iridium (Ir) and platinum (Pt). The metals and rare earth metals are oxidized into soluble ionic forms and then recovered from the solution. One or more metal(s) and/or rare earth metal(s) may be recovered. It may be possible to separate different co-solubilized metals at a later phase by using suitable method, for example precipitation method.

The material may be preprocessed or pretreated to remove impurities and/or metal(s) that is/are not desired to be recovered, such as iron or copper from electronic waste. This removal may be carried out using mechanical, chemical and/or magnetic method(s), which may be automated or semi-automated method(s), especially for crushed or pulverized material. Some impurities or metals may be removed manually. For example ferromagnetic metals may be separated by using magnetic separation method(s), and non-ferromagnetic metals, such as copper, may be separated by using mechanical methods which may include methods based on gravity and/or eddy currents. Such preprocessing or pretreating methods help minimizing chemical consumption in the leaching and/or recovery process and also enhance the cost efficiency and total efficiency of the whole process. The material may also be preprocessed or pretreated to obtain a desired particle size of the material, such as by using mechanical treatment, such as shredding, crushing or pulverizing, by using heat and/or by using chemical and/or liquid treatment, for example to swell the material and/or make it more prone to disintegration. The pretreatment or preprocessing may be carried out at a temperature over 80° C., preferably over 100° C., such as in the range of 100-210° C., 100-200° C. or 100-180° C. The pretreatment may take for example 0.5-12 hours, such as 0.5-2 hours. Such pretreatments may be useful especially for processing recycled circuit boards containing polymeric matrix and recoverable metals, but also other materials containing polymer-containing composite materials, such as PCB, glass fiber, carbon fiber reinforced composites, amines, epoxies and the like composites. The polymers may be solubilized, acid digested and/or depolymerized, such as by using high temperatures and/or organic solvents such as alcohols, for example benzyl alcohol. Hydrogen peroxide accelerates these processes so that reaction times a short as 0.5 h can be obtained. Acid digestion may be carried out by using a suitable acid, which may be weak/organic acid, such as acetic acid, for example glacial acetic acid, preferably in combination with hydrogen peroxide produced as disclosed herein, for example the reaction being carried out at temperatures disclosed in previous.

The reactions of the present methods are carried out in a solution, preferably in an aqueous solution, which may be also called as liquid or reaction solution. The solution may be a dispersion, such as a colloidal dispersion. The aqueous solution is water or water-based or water-containing solution, which may be formed by adding the ingredients to water. The aqueous solution may or may not contain organic solvents, or it may contain only traces of organic solvents, such as 5% (w/w) or less, for example 2% (w/w) or less or 1% (w/w) or less. The aqueous solution may contain other solvents or fluids as well, such as supercritical carbon dioxide. The reaction solution may contain water solvated in liquid, such as liquid and supercritical CO₂. The method comprises providing the metal-containing material, i.e. the material to be treated, to the aqueous solution. The material may be provided as suspended in an aqueous solution, and/or it may be provided to a solution containing one or more reagent(s) used in the method, such as to a solution containing one or more leaching agent precursor(s). The material may be provided before the leaching solution is obtained or it may be provided to the leaching solution, which is obtained with the method described herein, in the same container or in a different container. The material may be provided at once, at several times during the method, or continuously. The method may be carried out as a batch method or as a continuous method. The leaching step may be carried out as a batch method or as a continuous method. A batch leaching method may be applied for a time period required to obtain full or substantially full leaching of the metal(s) of interest. The material may be distributed at a length of a treatment area, for example in a case of a tubular reactor, and the leaching solution may be circulated or flowed through the treatment area. Alternatively the material may be circulated or moved though the leaching solution in a reactor, for example as unit doses or as a continuous form. A mixing may be provided to the leaching solution, for example by using one or more mixing and/or pumping means.

The method also comprises providing leaching agent precursor. The leaching agent precursor may be provided as dry and/or solid matter and/or in an aqueous solution. A leaching agent precursor solution may be formed or provided at a first location, such as in a container or a reactor, and it may be reacted into leaching solution at the first location or at a second location, such as a different container or reactor. The leaching agent precursor solution may be combined with a solution containing reactive species, such as solution containing hydrogen peroxide, which solution is formed by using the external energy, or the leaching agent precursor may be present in the solution which is treated with the external energy. The leaching agent or formed leaching agent precursor solution may be provided in or to a reactor, which comprises a container including one or more components of the devices disclosed herein. The method may comprise providing one or more reactor(s), or the device disclosed herein, which may be also called as a system, and optionally one or more further parts, means, devices or chemicals required to carry out desired method steps. The device may comprise means for receiving the leaching agent precursor, which may be means for receiving dry and/or solid matter and/or means for receiving aqueous solution or other solution, fluid or liquid. The device may contain a setup described herein, or a part thereof, optionally in combination with other setups or parts thereof disclosed herein.

The method comprises reacting the leaching agent precursor with the formed hydrogen peroxide to form a leaching agent and to obtain a leaching solution. The method comprises providing metal-containing material and reacting the metal-containing material with the leaching solution to obtain soluble metal complexes. The metal-containing material may be provided before the leaching agent is formed and/or after the leaching agent is formed.

The method comprises providing one or more source(s) of non-chemical external energy 10. The source of external energy 10 may be provided and/or placed to direct the energy to the aqueous solution 14, which may be water or a solution containing one or more agent(s), such as an aqueous solution of leaching agent precursor, or to a container or a reactor containing said aqueous solution. Preferably the aqueous solution is an aqueous solution of leaching agent precursor. The source of external energy may refer to means for providing the external energy, or the external energy may be provided with or via such means, for example with or via one or more electrode(s). The source of external energy 10 may be placed above the surface 16 of the aqueous solution 14, i.e. the source of external energy is not in contact with the aqueous solution, but there may be a gap of for example 1-50 mm, such as 1-10 mm or 1-5 mm. Alternatively the source of external energy may be placed to the aqueous solution, i.e arranged to be immersed or dipped to the aqueous solution. This depends on the type of external energy used. In some cases a part of the source of external energy 10 is partly in the solution and partly above the solution. In some cases the source of external energy is placed in the wall(s) of the reactor, or even at the other side of the wall of the reactor from the aqueous solution. The source of external energy may be fixed or it may be movable, in which case it may be moved or immersed into the solution or reactor and/or moved out from the solution or reactor.

The external energy is not chemical energy, i.e. it is not based on adding one or more chemical(s). The external energy is capable of forming reactive molecular species, such as radicals in the aqueous solution, which in turn are capable of forming and/or accelerating formation of higher oxidation states in molecules. Therefore reactive species are formed, which may lead to formation of for example hydrogen peroxide and/or other reagent(s) capable of reacting with the leaching agent precursor(s) to form leaching agent(s). Also these reagents may be reactive species. Preferably the reactive species desired, obtained, utilized, measured and/or detected in the present method is or comprises hydrogen peroxide. Especially the external energy is provided in form and/or with intensity or power high enough to form such reactive species in the aqueous solution. The external energy is provided by using a device providing the energy to the aqueous solution, such as a device comprising one or more source(s) of external energy, which makes the system simple and controllable. The device or the system is electrically operated and may be controlled electronically, which enables providing an automated, such as computerized, system and fast and accurate control. The source of the external energy may be initially electricity, for example electricity directly as the external energy or electricity as energy source for generating ultrasound, light, plasma or other energy type disclosed herein, which may be also considered as external energy. The device may be placed to a suitable location and directed to provide the energy to the solution. This also enables providing a device setup which is ready to be used and does not rely on adding external chemicals. The energy source may or may not be in contact with the aqueous solution during the use.

The external energy may be electricity, light, ultrasound, plasma, corona, glow-discharge electrolysis, contact glow discharge electrolysis (CGDE), or UV light, or in a form and/or combination thereof, or the external energy is arranged to provide electricity, such as electrosynthesis or electrolysis, light, ultrasound, plasma, corona, glow-discharge electrolysis, contact glow discharge electrolysis (CGDE), or UV light or combination thereof. The catalysts for the electrode materials mentioned herein can also be utilized enhancing glow-discharge electrolysis, such as contact glow discharge electrolysis (CGDE) effect for leaching solution activation by using special catalysts electrode materials such as surface treated or doped carbon materials to achieve higher redox potential. The method may comprise providing one or more source(s) of external energy comprising at least a source of electric current connected to one or more non-metallic electrode(s) for providing the electric current to the solution. The electrodes, or any other source of energy, may be provided in the aqueous solution. The source of external energy may (further) comprise, especially in addition to electric current, one or more (other) source(s) of electric current, one or more source(s) of ultrasound, one or more source(s) of laser, one or more fuel cell(s), one or more source(s) of glow-discharge electrolysis and/or one or more source(s) of contact glow discharge electrolysis (CGDE), and/or means for providing the energy to the aqueous solution. Two or more energy sources of different types may be applied. The source of external energy may comprise or be provided with one or more electrode(s), such as two, for example in a cell, connected to a source of electric current, which electrode(s) may be arranged to provide electrosynthesis or electrochemical reactions, such as electrosynthesis, electrolysis or electrolytic reaction in the reactor and/or in the aqueous solution. The method may comprise treating the aqueous solution with electric current to obtain electrosynthesis of hydrogen peroxide by oxygen reduction.

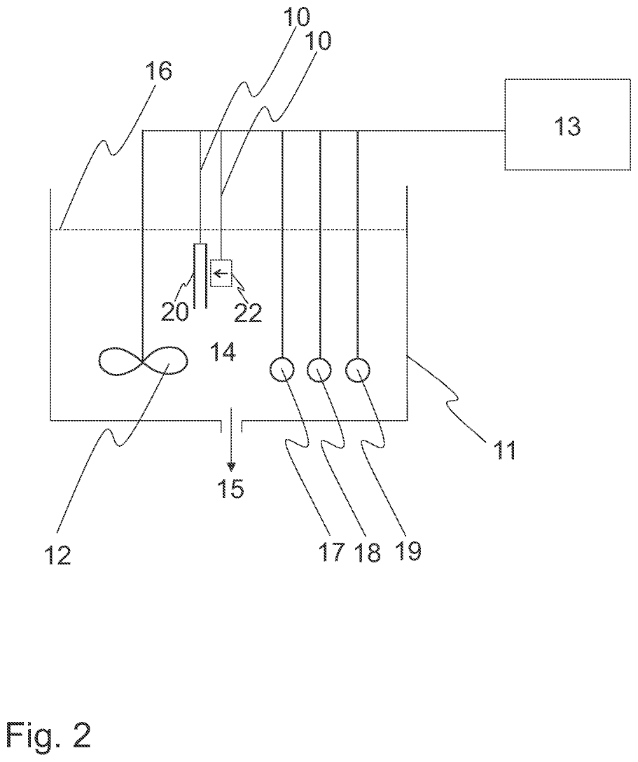

The primary source of external energy may be electricity or electric current, and correspondingly the primary method for forming the reactive species, preferably hydrogen peroxide, may be electrochemical, such as by electrolysis or electrosynthesis. One or more electrochemical routes may be utilized, such as oxygen reduction reaction via one or more routes, or other route(s). Other sources of energy as disclosed herein may be used to support the desired electrochemical reaction(s), such as ultrasound, laser, plasma and the like. FIG. 2 shows an example wherein source of electricity provided with electrodes 20 is the main/primary/first source of energy, thereby providing the main reaction or the first reaction, and optionally another source of external energy 22, such as ultrasound, which may be a second, a third or a further source of external energy, also correspondingly providing a second, a third or a further type of reaction, is provided to support the main source of energy or the main reaction. The supporting source of energy may be directed to the first (main) source of energy, such as to the electrode(s), so it can have an impact directly to the reactions occurring at the first source of energy, such as at the electrode(s). This enables efficiently enhancing and/or controlling the reactions provided by the first energy source. Alternatively the primary source of energy may be a source other than electricity, and the primary method may be other than electrochemical, such as a sonochemical method, a method utilizing light, plasma, corona, or other method disclosed herein, and a method utilizing electricity may be used to support the primary energy source/method.

Electrochemical methods can be used to produce hydrogen peroxide, for example by using two electrodes, anode and cathode, or three electrodes. Anode and cathode may be considered as a pair of electrodes. The device, system or for example a casing or cell may contain one or more pairs of electrodes, such as a fuel cell or a flow cell, such example a stacked electrode structure comprising a plurality of electrode pairs. The method is carried out in aqueous solution, which may be supplemented with oxygen and/or one or more electrolyte(s). It may be desired not to add any additional reagents, such as electrolytes, or reduce the amount of additional reagent compared to conventional methods, and/or to use green chemistry. Electrolysis may be carried out to reduce oxygen, for example by conventional methods using a mediator such as anthraquinone, and a catalyst such as nickel or palladium. This involves the hydrogenation, for example, of 2-alkyl-9,10-anthraquinone forming the corresponding hydroquinone, and oxidation with oxygen (usually air) to yield hydrogen peroxide and reforming the starting anthraquinone. An alternative and more preferred method comprises electrochemical reduction of oxygen to generate hydrogen peroxide. This called as oxygen reduction reaction and the reduction of oxygen may proceed by a direct four-electron pathway or a two-electron pathway.

In one example the external energy is electric current providing electrochemical oxygen reduction reaction. The method comprises
providing aqueous solution containing leaching agent precursor,
providing one or more source(s) of electric current to the aqueous solution,
treating the aqueous solution with the electric current to form hydrogen peroxide from oxygen in the aqueous solution, preferably by oxygen reduction reaction,
reacting the leaching agent precursor with the formed hydrogen peroxide to form a leaching agent and to obtain a leaching solution,
providing metal-containing material,
reacting the metal-containing material with the leaching solution to obtain soluble metal complexes, and
recovering the soluble metal complexes. The electric current may be provided to the aqueous solution with or via the electrodes disclosed herein.

According to one definition or embodiment the method comprises
providing aqueous solution containing leaching agent precursor and/or leaching agent,
providing one or more source(s) of electric current to the aqueous solution,
treating the aqueous solution with the electric current to form hydrogen peroxide from oxygen in the aqueous solution by oxygen reduction reaction,
providing the leaching agent or leaching agent precursor with the formed hydrogen peroxide to form a leaching agent and/or to provide oxidant and to obtain a leaching solution,
providing metal-containing material,
reacting the metal-containing material with the leaching solution to obtain soluble metal complexes, and
recovering the soluble metal complexes.

The hydrogen peroxide obtained in any one or more methods disclosed herein may be used in further reactions to obtain leaching agent(s) from a leaching agent precursor and/or to provide oxidant or oxidizing agent. The leaching agent precursor preferably does not comprise all final leaching agent(s), but it may comprise one or more agent(s) which is/are not the final leaching agent(s) of the method. The leaching agent may be obtained from the leaching agent precursor. The leaching agent may also comprise the leaching agent precursor and one or more additional reagent(s), such as hydrogen peroxide and optionally organic/weak acid, so that the leaching agent precursor alone may not be suitable for leaching. The leaching agent or leaching agent precursor may be provided with the hydrogen peroxide. The method may comprise reacting the leaching agent precursor with the hydrogen peroxide to form a leaching agent and to obtain a leaching solution. However the hydrogen peroxide may also act as a leaching agent, such as in combination with one or more reagents disclosed herein, such as leaching agent, leaching agent precursor and/or (supercritical) carbon dioxide.

### Oxygen Reduction

The method may comprise treating the aqueous solution with the external energy to obtain oxygen reduction reactions to form hydrogen peroxide. More particularly the method may provide and/or promote a synthesis of hydrogen peroxide by using oxygen reduction reaction pathway. Electrosynthetic or electrochemical methods and routes may be used, and the reaction conditions and used materials and devices, such as electrodes and/or catalytic materials, may be selected in such way that the facilitate the oxygen reduction route. It may be for example desired that oxygen reduction, preferably by using a selected route, would be the main reaction for producing reactive species. Main reaction means that over 50% by weight of the formed reactive species are obtained by such reaction, preferably more, such as (by weight) at least 70%, at least 80%, at least 90%, at least 95%, or substantially all. However minor amounts of other reactions may occur in the reaction solution even at optimal conditions favouring the selected reaction route.

Oxygen reduction in the present method can take place at least by two possible ways. Oxygen can reduce to water by direct 4-electron pathway (Equation 1 and 3) or to peroxide by 2-electron pathway (Equation 2 and 4). However in non-aqueous aprotic solvents and/or in alkaline solutions, a 1-electron reduction pathway from O₂ to superoxide (O₂⁻) can also occur.

While the two-electron reduction mechanism, forming hydrogen peroxide species, may undesirable from an energy efficiency standpoint (only 2 electrons transferred per oxygen molecule to form hydrogen peroxide as opposed to 4 to form water), this electrochemical reaction is advantageous because it can replace the energy intensive anthraquinone process conventionally used to synthesize hydrogen peroxide. Further, the two-electron pathway is especially useful at acidic conditions, so it may be preferred for leaching methods including halogens, such as KI, or thiourea. It may be desired to obtain such reaction conditions that facilitate the two-electron pathway. There is a close correlation between H₂O₂ product yield, the surface area of electrocatalytic material(s) and interfacial zeta potential. For example nitrogen doping of the catalytic material sharply boosts H₂O₂ activity and faradaic selectivity. Zeta potential refers to electrokinetic potential in colloidal dispersions. From a theoretical viewpoint, the zeta potential is the electric potential in the interfacial double layer at the location of the slipping plane relative to a point in the bulk fluid away from the interface.

Further, shifting electrochemical oxygen reduction towards two-electron pathway to hydrogen peroxide (H₂O₂), instead of the traditional four-electron to water, enables providing a green method for H₂O₂ generation. In one example Fe—C—O is provided as an efficient H₂O₂ catalyst with a high H₂O₂ selectivity of above 95% in both alkaline and neutral pH. Other selective and efficient catalysts are provided in this disclosure.

ΔE value of ORR is different at different pH values. Hence, the reaction can be written in different ways according to the medium at which the reaction is taking place. At the acidic medium (at pH=0, [H⁺_{(aq)}]=1 mol dm⁻³) two different pathways of ORR can be written as follows.

O₂(g)+4H⁺(aq)+4e⁻→2H₂O(I) E⁰=+1.229 V (1)

O₂(g)+2H⁺(aq)+2e⁻→2H₂O₂(I) E⁰=+0.670 V (2)

At the alkaline medium (pH=14, [OH⁻_{(aq)}]=1 mol dm⁻³) reactions are represented as Equation 3 and 4, respectively.

O₂(g)+2H₂O(aq)+4e⁻→4OH⁻(I) E⁰=+0.401 V (3)

O₂(g)+H₂O(aq)+2e⁻→HO₂⁻(I)+OH⁻ E⁰=−0.065 V (4)

The two-electron pathways provide unstable peroxide as reaction product, but this is not a problem when the peroxide is used immediately, for example to oxidize the leaching agent precursor.

The oxygen reduction reaction occurs at the cathode, where O₂ molecules are reduced by electrons. It is very difficult to electrochemically break the O═O bond, which possesses an exceptionally strong bond energy of 498 kJ mol⁻¹. The use of electrocatalysts for the bond activation and cleavage may be necessary to lower the energy barrier. The ORR at the cathode is more than six orders slower than hydrogen oxidation at the anode in aqueous solutions in the PEMFCs, arising from the varied adsorption/desorption and reaction pathways, which involve different O-containing intermediates (e.g. OOH*, O*, and OH*). As a result, the usage of catalyst for the cathode is usually ten times more than that for the anode. It may be however desired to avoid the hydrogen oxidation reaction or formation of hydrogen.

### Sonochemistry

In one embodiment the source of external energy 10 comprises one or more source(s) of ultrasound. Ultrasound may be used to obtain sonochemical reactions in the aqueous solution. Sonochemistry refers to use of ultrasound in chemical reactions in solution to provide activation based on a physical phenomenon called acoustic cavitation. Cavitation is a process in which mechanical activation destroys the attractive forces of molecules in the liquid phase. When applying ultrasound, compression of the liquid is followed by rarefaction (expansion), in which a sudden pressure drop forms small, oscillating bubbles of gaseous substances. These bubbles expand with each cycle of the applied ultrasonic energy until they reach an unstable size; they can then collide and/or violently collapse. The collapse of bubbles can be violent enough to lead to chemical effects, known as sonochemistry. These bubbles act as a localized hot spot generating temperatures of about 4000 K and pressures in excess of 1000 atmospheres.

When water, or aqueous solution, is sonicated, adiabatic collapse of cavitation bubbles leads to the formation of reactive oxygen species or other reactive species, such as radicals, for example hydroxyl radicals (.OH), and hydroperoxyl radicals (HOO.), and hydrogen peroxide (H₂O₂). More particularly, when an aqueous solution is irradiated ultrasonically, OH radicals and H radicals are produced by cavitation in a sonolysis. The hydroxyl radicals combine with one another to form H₂O₂, which is released to the aqueous solution or medium.

By providing external energy to water or aqueous solution, it is possible to obtain reactive species, more particularly reactive molecule species or reactive molecules, which may be oxidative or reactive oxygen species or other oxidative or reactive species, such as chlorine species or other species obtained by first providing these species. The reactive species may be reactive oxygen species, such as radicals, for example hydroxyl radicals (.OH), hydroperoxyl radicals (HOO.), and hydrogen peroxide (H₂O₂). These reactions may be obtained with different types of external energy. The reactive species may be used to obtain further reactive agents.

### H₂O→H.+.OH

### O₂→2O

### H.+O₂→.OOH

### O+H₂O→2.OH

### H.+O₂→.OH+O

The hydroxyl radical exhibits a high oxidation potential and can oxidize organic substrates directly, causing their degradation or mineralization. The hydroxyl radicals have a very short lifetime, and they tend to combine with one another to form H₂O₂, which is released to the aqueous solution or medium (reactions 5 and 6).

2.OH→H₂O₂ (5)

2.OOH→H₂O₂+O₂ (6)

The radicals and hydrogen peroxide obtained in these reactions are reactive species, more particularly reactive oxygen species, which are capable of reacting with other molecules, such as with the leaching agent precursor(s) to form leaching agent(s). The formation of leaching agent(s) in the aqueous solution causes formation of a leaching solution.

The obtained hydrogen peroxide may be used in further reactions to obtain leaching agent(s) from a leaching agent precursor and/or to provide oxidant or oxidizing agent. The leaching agent precursor preferably does not comprise final leaching agent(s), but it comprises one or more agent(s) which is/are not the final leaching agent(s) of the method. The leaching agent may be obtained from the leaching precursor. The leaching agent or leaching agent precursor is provided with the hydrogen peroxide. The method may comprise reacting the leaching agent precursor with the hydrogen peroxide to form a leaching agent and to obtain a leaching solution

Ultrasound may be used to facilitate oxygen reduction reaction. This may be carried out in combination with electrochemical/electrosynthetic reactions, more particularly electrochemical oxygen reduction and/or hydrogel evolution reactions. The application of ultrasound can increase the cumulative concentration of hydrogen peroxide and also the current efficiency. Further, ultrasound may be combined with the use of catalyst(s) or materials providing catalytic properties, such as electrodes, catalysts and/or scavenger materials disclosed herein. This may result in selective conversion, such as selective oxidation, of substrates to desired reaction products. This may be due to enhanced chemical effects, such as production of HO through in situ formation of H₂O₂ in the sonicated solution, and physical effects, such as increased mass transfer, which may be promoted by ultrasound on the catalyst surface. It was found out that the frequency range 15-40 kHz is suitable in respect of kinetics and mechanisms of the present electrochemical reactions. A specific electrode may provide catalytic properties especially or only when ultrasound is used.

The reactions may be controlled by combining electrochemical method(s) and ultrasound. The method may therefore comprise providing two or more source(s) of external energy, preferable a source of ultrasound and a source of electric current, and treating the aqueous solution with electric current to obtain electrosynthesis of hydrogen peroxide assisted by ultrasound to form hydrogen peroxide from oxygen in the aqueous solution by oxygen reduction. Assisted by ultrasound means that the electrochemical reaction is the main reaction of generating hydrogen peroxide. Ultrasound may be used to supplement or control the reaction.

Other Sources of External Energy

In one embodiment the source of external energy 10 comprises one or more source(s) of laser. It was found out that laser may be used to decompose water to form H₂, O₂ and H₂O₂. This is especially efficient in colloidal solutions, such as solutions or dispersions containing nano scale particles. A colloid is a mixture in which one substance of microscopically dispersed insoluble or soluble particles is suspended throughout another substance. The metal-containing material which is treated in the present methods may form a colloid, which can be therefore efficiently treated with laser or other methods suitable for colloidal dispersions. The formation of hydrogen peroxide depends on the laser fluence in the solution.

In one embodiment the source of external energy 10 comprises one or more fuel cell(s).

The method comprises treating the aqueous solution with the external energy to form hydrogen peroxide from oxygen in the aqueous solution by oxygen reduction reaction or pathway. This may be affected or controlled by using suitable chemical environment, such as suitable reagent(s) and concentration(s) thereof, suitable pH, suitable level of external energy, suitable level of formed reactive species or combinations thereof.

The aqueous solution may be mixed during the treatment, such as by using one or more mixer(s), stirrer(s), agitator(s) or the like mechanical mixing means or otherwise providing mixing force to the solution, and/or by using one or more pump(s). The method may comprise maintaining a desired temperature, such as by cooling and/or heating the aqueous solution, preferably with one or more means for adjusting temperature, such as one or more cooling and/or heating means, to maintain the desired temperature. A desired temperature may be 100° C. or less, 90° C. or less, 80° C. or less, 70° C. or less, 60° C. or less, 50° C. or less, 40° C. or less or ° C. or less. Temperatures in the range of 0-70° C., 10-60° C., 10-50° C., 20-60° C., 20-50° C. or 20-40° C. may be used, for example in cases wherein formation of fumes is to be avoided.

Hydrogen peroxide (H₂O₂) is a strong oxidant, which can be used in leaching process. In the present method hydrogen peroxide is produced in situ and/or on site, so that there is no need to purchase, store and/or transport it as a separate chemical to the site of use. When the hydrogen peroxide is produced using electrochemical reactions and equipment, it is possible to control the reactions electronically. By monitoring the reaction solution by using one or more sensors it is possible to adjust and/or control the electrosynthesis of hydrogen peroxide as a feedback to the monitored data to maintain the reactions at a desired (predetermined) level. When hydrogen peroxide is produced with oxygen reduction reactions, either partly or completely or substantially completely, the control of the process is enhanced. For example the selective formation of hydrogen peroxide specifically can be obtained. Hydrogen peroxide can be produced at either an anode or a cathode surface.

It is challenging to develop H₂O₂ electrosynthesis catalysts because many common electrode materials favour competing reactions. Reactions such as the 4e⁻ reduction of O₂ (the oxygen reduction reaction, ORR) and 4e⁻ oxidation of 2H₂O (the oxygen evolution reaction, OER) may occur, and they may or may not be desired. In one example 2e⁻ reduction of O₂ or 2e⁻ oxidation of 2H₂O to get H₂O₂ is desired. The electrosynthesis of H₂O₂ is a relatively unusual process because it involves reversible redox reactions of starting materials, intermediates and products.

It is also possible to provide one or more electrolytic agent(s) to the solution to facilitate the electrochemical reactions, especially when using specific electrodes, catalytic materials and/or leaching agents or precursors. For example if KI or thiourea and organic acid, such as citric acid, are used, electrolytes such as NaCl, sodium sulphite, Na₂SO₄, citrate, oxalate or malate may be added.

The aqueous solution may be mixed during the treatment, such as by using one or more mixer(s), stirrer(s), agitator(s) or the like mechanical mixing means or otherwise providing mixing force to the solution. The method may comprise maintaining a desired temperature, such as by cooling the aqueous solution, preferably with one or more cooling means, to maintain the desired temperature. A desired temperature may be 100° C. or less, 90° C. or less, 80° C. or less, 70° C. or less, 60° C. or less, 50° C. or less, 40° C. or less or ° C. or less. Temperatures in the range of 0-70° C., 10-60° C., 10-50° C., 20-60° C., 20-50° C. or 20-40° C. may be used, for example in cases wherein formation of fumes is to be avoided.

### Catalytic Materials

The main reaction route to obtain reactive species may be an electrosynthetic route, such as oxygen reduction reaction. Electrosynthetic methods usually involve electrodes, which may be in a form of solid pieces, such as bars, wires, strips or the like, but they may also be in a form of a membrane, a sheet, a filter and the like structures. The electrodes may be provided as a stack of one or more of the above-mentioned. The body of an electrode may consist of or substantially consist of single type of material, such as metal or non-metal, for example carbon, or it may be a mixture or a composite of two or more materials. The electrodes are connected or arranged to be connected i.e. connectable to a source of electric current. The method and system may comprise providing electrodes and/or providing a source of external energy via electrodes. In the present method it is desired to use green chemistry when possible as well as new catalytic materials, so that the reactions can be carried out for example without using anthraquinone or the like conventional chemicals. It may also be desired to avoid using expensive noble metal catalysts, or metallic materials in general, as they may not tolerate the leaching process conditions or may not be suitable to be used for leaching noble metals, especially the same metal such as platinum.

In electrosynthesis of H₂O₂ it may be desired to use a cell including electrodes. An ideal electrode structure should have a sufficiently large number of adsorption sites, whilst also allowing H₂O₂ to rapidly desorb before it can undergo further reactions. To obtain desorption of H₂O₂ it is desired to have weak or none metal-H₂O₂ interactions and conditions enabling fast mass transport. To obtain industrial scale system, it is also desired to provide high surface areas and fast mass transport.

The method may comprise providing a source of external energy via a cell comprising electrodes. The electrodes are arranged to be contacted with the solution. The device or system may comprise such a cell. The cell may be a flow cell, gas diffusion electrode, a trickle bed reactor or a fuel cell. The cell may include a casing with one or more inlet(s) and one or more outlet(s) for the aqueous solution.

In one example the cell includes a proton exchange membrane (PEM). It may divide the cell into two compartments, which may have one or more electrode(s) on each compartment, for example anode(s) at a first compartment and cathode(s) at a second compartment. Electricity is connected to the electrodes. Water may flow though the first compartment, wherein it is electrolysed to provide protons, which pass the proton exchange membrane to the second compartment. O₂ in water is fed to the second compartment, wherein it is oxidized at the cathode and hydrogen peroxide is formed, which can be outputted from the cell. Cathode catalysts may be provided, such as vapor-grown carbon fibers (VGCF), activated carbon with VGCF, oxidized activated carbon with VGCF, Co-NX, or Mn-NX.

A proton-exchange membrane, or polymer-electrolyte membrane (PEM), is a semipermeable membrane generally made from ionomers and designed to conduct protons while acting as an electronic insulator and reactant barrier, e.g. to oxygen and hydrogen gas. A proton exchange membrane may be based on suitable polymer(s) or composites thereof. The polymer may be a fluoropolymer, such as sulfonated tetrafluoroethylene based fluoropolymer-copolymer, for example Nafion®.

It may be desired to avoid using metallic electrodes, such as electrodes based on or comprising iron, steel, platinum or titanium, or other metals, which are expensive and/or prone to corrosion at the conditions used in the processes disclosed herein. Therefore it may be preferable that the electrode or the body of the electrode, is based on, comprise or consist of non-metallic materials(s). The non-metallic material may be conductive or it may be non-conductive or poorly conductive. In the electrochemical use however conductive material is required, but the conductivity may be also provided by a suitable coating, which may be a catalytic coating disclosed herein or other coating. In catalytic use an electrode or similar body does not need to be conductive. Preferably one or more, or all, of the electrodes are non-metallic electrodes. Non-metallic electrode may however contain metallic or metal-containing coating, such as catalytic coating, i.e. a metal-containing catalyst. The coating may coat the body of the electrode completely, substantially completely or partially. Such non-metallic electrodes have a very long working life. The use of non-metallic catalysts or other catalysts disclosed herein may be desired to avoid hydrogenation of decomposition of hydrogen peroxide to water by a catalyst in a hydrogen peroxide synthesis, as is the case for example with palladium-based catalysts. The non-metallic electrodes favor the oxygen reduction reaction, especially via two-electron pathway. However also carbon materials may be prone to corrosion at acidic conditions, so it may be necessary to provide carbon materials in modified form, such as carbon nanotubes, glass-like carbon or the like. However, it may be possible to provide one or more metallic electrode(s) in addition to one or more non-metallic electrode(s).

The non-metal may be or comprise carbon or material derived from carbon. General advantages of such carbon-based materials include satisfactory cost, structure diversity, good electrical and thermal conductivity, as well as a combination of mechanical strength and lightness that conventional materials cannot match.

The electrode, such as non-metallic electrode, for example carbon-based electrode, may be porous or it may contain porous areas, such as the surface. Porous electrode provides high surface area which is advantageous in the electrochemical methods. The porous electrode may be cathode and/or anode. However cathodes may benefit more about the porosity. Carbon electrodes may be called as 3D carbonaceous electrodes, especially 3D porous carbonaceous electrodes. 3D porous carbonaceous electrodes provide multiple advantages, including high electronic conductivity, tunable molecular structure, abundance, enhanced accessibility of active sites and transport properties of reaction-relevant species, increased electron transfer through whole electrodes, and strong tolerance to acidic/alkaline environments. Moreover, their metal-free nature also avoids the possible release of metal ions, and hence reduces their environmental impact.

The carbon-based electrode may comprise carbon nanomaterial or other carbon-based materials disclosed herein. Carbon nanomaterials, such as nanotubes, nanobuds or nanofibers or fibrils, and other carbon-based materials such as graphite or graphene, which may or may not be nanomaterials, may provide specific catalytic properties, such as selectivity, stability and efficiency. Carbon (nano)materials, which may be modified, such as doped or otherwise activated or treated, may enhance hydrogen peroxide production by means of surface activation of the carbon material. They may help decreasing overpotential even up to 90%, especially at neutral or basic conditions. Oxygen reduction reaction is positively correlated with the oxygen content of the material, especially C—O and C═O functional groups. In general nanomaterials refer to materials having at least one dimension, preferably all, at a nanoscale range, such as less than 1 μm, less than 500 nm, less than 200 nm, less than 100 nm, less than 50 nm, or less than 10 nm.

The source of external energy 10 may comprise or may be provided with one or more non-metallic electrode(s), such as electrode(s) comprising carbon material(s) and/or derivatives thereof, such as graphite and/or derivatives thereof, graphene and/or derivatives thereof, or carbon nanomaterial(s) and/or derivatives thereof, such as carbon nanofibers, carbon nanotubes or carbon nanobuds, or π-conjugated polymers such as polyaryls and poly(aryl-acenaphthenequinonediimine). The source of external energy 10 may comprise or may be provided only with or by non-metallic electrode(s), so preferably the system and/or method does not contain metallic electrode(s). One or more metal electrode(s) may be used in addition to non-metallic electrode(s), such as an electrode comprising iron, steel or TiO₂. Preferably such metal or metal-based electrode is not used for providing the primary external energy. Metallic electrode may be coated or otherwise provided with one or more catalytic material(s) disclosed herein. In general a coating on an electrode, metallic or non-metallic, may help overcoming challenges relating to overheating relating to use of high current and therefore reduce the need for cooling. Preferably the electrode(s) are used to or arranged to provide electrolysis in the reactor. Preferably the desired reaction is oxygen reduction which is obtained electrochemically. Examples of carbon based materials, which may be used in electrodes and/or as separate catalytic materials, especially for favouring ORR, include the carbon-based materials mentioned herein and derivatives thereof, such as highly oriented pyrolytic graphite (HOPG), pyrolytic graphite (PG), graphite powder, porous graphite, natural graphite, glassy carbon (GC), pyrolytic carbon, active carbon, carbon black and carbon single crystals. An electrode may comprise these and/or other functional materials, which means that the materials may be on the electrode, in the electrode, or the electrode may be based or substantially based on such material(s).

Non-metallic electrode may comprise carbon or it may be a carbon electrode, such as the body of the electrode comprises carbon, which may be further treated, doped and/or coated with additional material(s). The carbon may be porous carbon, such as hierarchically porous carbon (HPC). The carbon may be activated. Porous, particular, nanostructured or otherwise specifically structured or treated carbon usually have a large surface area, which facilitates the desired chemical reactions. Such electrodes may be used at least as cathodes in electrochemical methods and systems. Carbon-based electrodes can be used especially for cathodic electrosynthesis, as they exhibit poor efficiency for four-electron oxygen reduction reaction but favour the two-electron pathway. The non-carbon electrodes may also show enhanced capacitance, such as electrodes comprising graphene or CNT-BDD, which may be preferred for example in ORR reactions.

Carbon-based materials as disclosed herein may act as carbocatalysts. It may be desired to use such metal-free catalytic materials in the present method. The carbon-based materials may be surface-treated, surface-activated and/or doped with one or more heteroatom(s), such as nitrogen (N), phosphor (P), boron (B) and/or sulphur (S). It was especially found out that in oxygen reduction reactions the electrocatalytic properties of carbon materials are remarkably enhanced by heteroatom doping, such as N doping. The doping may be single doping, or binary or ternary doping. Regarding single doping with N atoms, there are usually four N species in N-doped carbon materials, including pyridinic N, pyrrolic N, quaternary N (also called quaternary-N), and N-oxides of pyridinic N. Upon N co-doping with other heteroatoms, the resultant co-doped carbon materials may be more electrocatalytic active towards ORR than the single-doped counterpart. Therefore the carbon-based materials may be doped with heteroatoms comprising at least N, but optionally one or more heteroatoms selected from P, B and S. Carbon based materials may be provided as carbon foam, such as N-doped carbon foam, which may be called three-dimensional material. Such structure can facilitate the mass transfer, which is beneficial to enhance H₂O₂ production from oxygen reduction

Catalytic materials and/or other functional materials and/or groups may be immobilized onto electrode surface via physical adsorption or via attachment of the catalytic compound by an electrochemical reduction of the appropriate salt of the compound or by any other suitable immobilization techniques. Such immobilized catalysts may increase the rate of ORR on a carbon electrode. The catalytic compound may comprise one or more of the catalytic compounds and materials disclosed herein. Examples of such catalysts include metal-containing catalysts, such as Co(II)-macrocycle complexes, manganese dioxide, copper-nickel alloys, cobaloxime complexes, transition metal phthalocyanines or gold nanoparticles, and non-metal catalysts such as carbon materials disclosed herein, such as nanostructured carbon, for example carbon nanotubes, or quinones. In one example the electrode comprises one or more catalyst(s) and/or functional group(s) immobilized on the electrode. The functional groups may include any group disclosed herein, such as a group included in a catalytic compound, a group obtained by doping, a quinonoid type of functional group, such as 9,10-phenanthraquinone, PAQ, naphthazarin (5,8-dihydroxy-1,4-naphthoquinone) and/or juglone (5-hydroxy-1,4-naphthoquinone).

Graphene is an allotrope of carbon in the form of a single layer of atoms in a two-dimensional hexagonal lattice in which one atom forms each vertex. Graphene has a very high surface-to-volume ratio. Graphene and derivatives thereof (graphene-based substances), such as doped graphene, can provide catalytic properties in the oxygen reduction reaction and in other reactions. Graphene may be doped with various heteroatoms, such as nitrogen (N), phosphor (P) or sulphur (S). N-doped graphene is preferred as it is very active and selective in oxygen reduction reaction. In one example cobalt, such as Co—N₄ molecules, are incorporated in nitrogen-doped graphene, thus highly enhancing the production of hydrogen peroxide. Other derivatives of graphene include graphene oxide (GO) and reduced graphene oxide (RGO), such as electrochemically reduced graphene oxide (ErGO). GO has hydroxyl, epoxy and carboxyl groups at the edges and on the basal plane, which make the GO materials hydrophilic and dispersible in aqueous solutions. Such surface functionalities favour good dispersion of catalyst nanoparticles on RGO carrier increasing the electrochemically active surface area. GO electrodes provide enhanced capacitance and preferable ORR onset potential.

Carbon based material may comprise glass-like carbon, also called glassy carbon or vitreous carbon. It is a non-graphitizing, or nongraphitizable, carbon which combines glassy and ceramic properties with those of graphite. The most important properties are high temperature resistance, hardness (about 7 Mohs), low density, low electrical resistance, low friction, low thermal resistance, extreme resistance to chemical attack and impermeability to gases and liquids. Glass-like carbon may be produced by pyrolyzing polymer resins with a high density of cross-links to produce a highly disordered form of carbon. Its electrocatalytical properties are largely dependent on the electrode surface functionalisation (presence of surface groups like —C═O, —C—OH or—COOH). The largest electrocatalytic activity is ascribed to the surface —C═O group moieties which are relatively scarce at the pristine/non activated glass-like carbon surface. Glass-like carbon can be activated with methods based on surface cleaning, polishing, plasma etching, vacuum and/or thermal treatments, chemical modifications and also electrochemical modifications. In one example an electrode is an anodically pretreated glassy carbon (AP-GC) electrode, such as one comprising one or more quinone group(s). An increase in the surface-quinone concentrations results in a shift of the oxygen reduction peak potential at AP-GC electrode in a positive direction, and the potential and peak current are practically unaffected by pH.

Carbon-based materials may be provided in different forms, which may be used as electrodes and/or as separate catalytic materials. Examples of such forms include sheets, films, membranes, filters, felts, cloths, powder, and porous materials and objects. Forms providing high surface are may be preferred. Carbon may be provided as pure or as composite, for example together with plastic polymer, metal, glass, fibers, and/or catalytic material(s) such as disclosed herein. Such carbon-based materials may be included in flow cells or reactors, so that they can be used in the present methods. Examples of such materials include graphite felt, carbon cloth, and reticulated vitreous carbon (RVC), with and without dopants on its carbon matrixes

The electrochemical properties, such as behaviour and activity, of carbon material may depend on pretreatment of the electrode. It may be also necessary to renew and/or activate the surface periodically during use. The surface of an electrode, especially glassy carbon electrode, may be polished with abrasive material, such as alumina, silicon oxide or diamond slurry. Other surface treatment methods for activation include electrochemical and chemical oxidation, exposure to radio frequency plasmas, heating at low pressures, in situ laser irradiation, vacuum heat treatment and dispersion of metal oxides. The surface treatment or activation methods result in removal of surface impurities and exposure of carbon. A pretreatment may be oxidative treatment, such as electrochemical oxidation or chemical oxidation, which results in increase in the oxygen reduction rate.

The electrode, such as non-metallic electrode, may be surface-treated or surface-activated. Surface-treatment or activation may refer to immobilization of substances or materials, or to treatment of the surface with mechanical methods or other methods such as by using plasma or laser. In one embodiment the one or more non-metallic electrode(s) comprise one or more surface-treated or surface-activated electrode(s), such as plasma or laser surface-treated electrode(s), and/or one or more electrode(s) doped with metal-based agents or catalysts such as Co(II) macrocycle complex(es), manganese dioxide, copper-nickel alloy(s), cobaloxime complex(es), transition metal phtalocyanine(s), nanoparticles of Fe₂O₃ or CO₃O₄, or an electrode including or doped with non-metallic agents or catalysts such as quinones, carbon nanotubes, mesoporous carbon, doped carbon such as N-doped carbon, N-doped carbon nanotubes or N-doped graphite, boron-doped diamond, azobenzene, and/or nitrogen. The N-doped carbon may be N-doped mesoporous carbon or N-doped carbon nanotube. By using such surface-treated and/or catalytic materials it is possible to reduce the risk over overpotential and direct the reactions more efficiently and selectively towards oxygen reduction. Depending on the surface-treated or doped materials, as well as the used leaching agent precursor, the pH of the reaction solution may have a great impact on the efficiency of the reaction. It has been found out that carbon nanomaterials, such as N-doped carbon nanotubes, perform better than conventional Pt/C electrodes and provide high catalytic efficiency and long-term durability. Compared to non-doped carbon nanotubes, at which H₂O₂ may be oxidized or reduced at large overpotentials, the N-doped carbon nanotubes can significantly reduce the overpotential. Carbon nanotubes may be provided as a hybrid with other compound(s), for example fullerene, such as fullerene 60 (C60)-carbon nanotubes (CNTs) hybrid with covalently attached C60 onto outer surface of CNTs. Such a hybrid, which may be called a carbon nanobud, shows high efficiencies on electro-generating H₂O₂, owing to huge surface area and intermolecular electron-transfer in the hybrid structure. In one example the N-doped carbon nanotube comprises Fe—N-doping, which is effective for ORR. Such materials can be prepared by a simple and scalable atomic isolation method, in which a metal isolation agent is introduced to isolate Fe atoms and then evaporated to produce abundant micropores that host single Fe atom active sites.

Carbon nanotubes may refer to single-wall carbon nanotubes (SWCNTs) with diameters in the range of about a nanometer or to multi-wall carbon nanotubes (MWCNTs) consisting of nested single-wall carbon nanotubes. However carbon nanotubes may also refer to tubes with an undetermined carbon-wall structure and a diameter less than 100 nm. Individual carbon nanotubes naturally align themselves into “ropes” or “yarns” held together by relatively weak van der Waals forces. In one example carbon nanotubes are provided as bundles or yarns having an average diameter of 50 nm or less, such as 10-50 nm.

Carbon nanobud (CNB) refers to a material that combines carbon nanotubes and spheroidal fullerenes, both allotropes of carbon, in the same structure, forming “buds” attached to the tubes. The fullerenes are covalently bonded to the outer sidewalls of the underlying nanotube. Consequently, nanobuds exhibit properties of both carbon nanotubes and fullerenes. This structure has electronic properties that differ from those of fullerenes and carbon nanotubes (CNTs) alone. Carbon nanobuds exhibit lower field thresholds and higher current densities and electric field emission than single wall carbon nanotubes. The chemical bonds between the nanotube's wall and the fullerenes on the surface can lead to charge transfer between the surfaces. The presence of fullerenes in carbon nanobuds lead to smaller bundle formation and larger chemical reactivity Carbon nanobuds can engage in cycloaddition reactions and easily form chemical bonds capable of attaching molecules with complex structures. This can be explained by a greater availability of CNB surface to the reactants the presence of π-conjugated structures, and having 5-atom rings with excess pirimidization energy.

Carbon nanobuds may be defined as fullerene-functionalized carbon nanotube, wherein the carbon nanotube comprises one or more fullerenes and/or fullerene based molecules covalently bonded to the carbon nanotube. The one or more fullerenes and/or fullerene based molecules may be covalently bonded to the outer surface and/or to the inner surface of the carbon nanotube. The fullerene and/or fullerene based molecule may comprise 20-1000 atoms. The fullerene and/or fullerene based molecule may be covalently bonded via one or more bridging groups, which may comprise oxygen, hydrogen, nitrogen, sulphur, an amino, a thiol, an ether, an ester, a carboxylic group and/or a carbon-containing group, and/or the fullerene and/or fullerene based molecule may be directly covalently bonded. The carbon nanotube may comprise a single, a double or a multiple walled carbon nanotube or a composite carbon nanotube.

Such materials may be used on, in or as cathodes. Examples of suitable materials for cathodes for electroproduction of hydrogen peroxide include carbon nanotube, mesoporous carbon, N—C mesoporous carbon, boron doped diamond, Co(II)phthalocyanine, Fe(II)phthalocyanine, Pt/S doped carbon, Au_{0.92}/Pd_{0.08}/carbon black, Sn₆Ni carbon black, CeO₂ carbon black, WO₃ vulcan carbon IrO₂/Ta₂O₅, B-doped CNTs or graphene (BG), sulfur-doped graphene (SG), phosphorous-doped graphite layers, iodine-doped graphene, edge-halogenated (Cl, Br or I) graphene nanoplatelets (GnPs), B, N co-doped VA-CNTs or graphene, N, S-doped graphene (NSG), N, P-doped graphene (NPG), N, B, P-doped carbon. Examples of suitable electrode materials for anodes for electroproduction of hydrogen peroxide include metal oxides such as BiVO₄ and CaSnO₃. In one example an electrode comprises surfactant-exfoliated 2D hexagonal boron nitride (2D-hBN) nanosheets, which provide large quantifiable voltammetric signatures indicating electrocatalytic activity towards the oxygen reduction reaction. These materials also provide very high capacitance.

The surface-treated, surface-activated and/or doped electrodes may act as catalysts in the reactions. This enables use of non-precious catalytic materials, such as carbon, which may be doped and/or for example plasma-treated or laser-treated. For example a carbon support may be treated with an Ar−, N₂− or Ar:O₂-radio frequency (RF) plasma to obtain carbon supported Fe—N/C or Co—N/C catalysts. Carbon material catalysts can be used in electrochemical ORR methods to replace expensive noble metal catalysts. ORR by using carbon material catalysts may produce more hydrogen peroxide via two-electron reaction pathway than the noble metal catalysts in acidic conditions.

The electrodes disclosed herein may act as catalysts even without electric current. Such properties may be used for example when another source of external energy is used, for example ultrasound. Therefore it is possible to utilize the catalytic properties of the electrode in electrochemical reaction(s) and support the process with ultrasound even if the electricity is switched off or the use of electricity is decreased as the electrode material may provide the catalytic properties in the reactions relating to the other source of energy.

Surface treatment may also comprise a coating. Therefore an electrode, or other catalytic material or object, may be coated with one or more layer(s) of substances or coatings. In one example an electrode is coated with modified diamond, such as doped diamond, for example boron-doped diamond (BDD), such as polycrystalline BDD. The electrode may be also coated with materials, such as nanomaterials, deposited or coated with nanodiamonds or the like nanostructured diamond material. The diamond may comprise nanoscale diamonds and/or nanostructured diamonds. The term “nanostructured” may comprise nanodiamonds. The diamond materials may be also nanostructured. Diamond exhibits very high overpotentials for the chemical species following the inner-sphere mechanism because of the inertness of the surface for adsorption. This is the reason it exhibits high overpotentials for the oxygen and hydrogen evolution resulting in a wide electrochemical potential window. While this helps in the electroanalysis of a wide variety of chemical species, the inactiveness of diamond electrode for certain species such as H₂O₂ necessitates the modification of the diamond electrode with catalysts to activate it. For example, deposition of small amounts of IrOx clusters on the diamond surface dramatically enhances both the oxygen evolution reaction and the oxidation of organics in the potential region of water decomposition. The quality of conducting diamond films may be investigated by recording the background cyclic voltammetric j-E curves of the electrodes. The magnitude of the background current, the working potential window and the features of the curves are sensitive to the presence of non-diamond carbon impurities. In general, high quality diamond film has a flat, featureless voltammetric response in the potential range between −0.3 and 1.2 V vs. SHE, with a background current 10 times lower than polished glassy carbon. The wide potential window without electrolyte decomposition and the high stability of diamond allow electrochemical reactions to be carried out at potentials otherwise difficult to reach.

The BDD electrodes are characterized by very slow kinetics of inner-sphere reactions such as O₂ evolution. A very high overpotentials are required for these kind of processes. The very weak bond between the diamond surface and active intermediates (hydroxyl radicals) is the cause of the slow kinetics of this kind of a reaction. However, the weakly bonded hydroxyl radicals are chemically extremely active, and at potentials close to oxygen evolution, the oxidation of organics results in a complete combustion incineration of the organic species. In this potential region, all fouling effects are avoided and a very high current efficiency is obtained. The nature of the electrode material strongly influences both the selectivity and the efficiency of the process.

In one example diamond is nanostructured, which increases the sensitivity and performance in electrodes. The nanostructured diamond may comprise BDD. The nanostructured diamonds may be combined with carbon nanomaterials, for example coated or deposited onto the carbon nanomaterials. Deposition may be carried out by using electrospraying or other suitable technique. For example BDD thin films may be deposited onto carbon nanotubes (CNT). A porous material especially suitable for electrodes is obtained. The CNTs may be exposed to a suspension of nanodiamond in methanol causing them to clump together into “teepee” or “honeycomb” structures. A BDD-CNT hybrid material may be also prepared by using electrostatic self-assembly of nanodiamond, wherein a dense layer of nanodiamond particles are attached to the outer wall of the CNTs. Not only do these electrodes possess the excellent characteristics similar to BDD, such as large potential window, chemical inertness and low background levels, but also they have electroactive areas and double-layer capacitance values ˜450 times greater than those for the equivalent flat BDD electrodes. Therefore the electrochemical performance of BDD-CNT electrodes is highly enhanced.

Also a thin film may be coated with boron-doped diamond, and it may act as an electro or other catalytic material. Such a structure, especially as an electrode, works well at acidic conditions and is suitable for leaching agents and precursors applied with acids, such as organic and/or weak acids. Such material may provide catalytic activity also in other methods using external energy, such as fuel cells, ultrasound, plasma etc. Also atomically dispersed metal catalysts (ADMCs) may be provided as a coating on a material. Such structures may provide electrocatalytic properties, and may be used for example in ORR applications and in fuel cells.

The surface-treated, surface-activated and/or doped special materials, such as electrodes, catalytes and the like, may facilitate the oxygen reduction reaction, especially when combined with the external energies or combinations thereof. The special materials may react to ultrasound, plasma, laser and other types of external energy in such way that the reaction mainly obtained by using electrosynthesis or other type of energy is facilitated, enhanced and/or controlled, and the selectivity of the reaction(s) may be increased. Especially the H₂O₂ selectivity at acidic conditions may be increased.

The above doping agents or other materials or additives may act as catalysts, but also separate and/or further catalytic materials may be provided. The method may comprise providing one or more catalyst(s), preferably as separate material from the electrodes, for example immobilized or packed in a flow-through cell or the like casing, or deposited or immobilized onto a surface, for example on a surface of a reactor, a tube, a cell, or a structure formed in such way that exhibits large surface area, such as a structure obtained by additive manufacturing, for example as disclosed herein for scavenger materials. Examples of such catalytic materials include molybdenum, graphite, graphene or graphene-based catalyst(s), carbon fibers, carbon nanomaterials such as carbon nanofibers, carbon nanotubes or carbon nanobuds, carbon black, such as functionalized carbon black, which may be present as nanoparticles, ruthenium or complexed thereof, such as Ru^{III}-EDTA-complex, platinum, titanium, ScCl₃, π-conjugated polymers such as polyaryls and poly(aryl-acenaphthenequinonediimine). The catalyst(s) may be provided to the reaction solution or reaction mixture, for example as aqueous solution, as aqueous dispersion, or as solid. The catalysts may be also immobilized on an electrode. Especially the carbon-based materials may provide non-toxic catalysts which may enable production of hydrogen peroxide even in electrolyte-free media.

In one example the catalytic material comprises Co-based catalytic material(s), such as Co—N/CN. Co—N/CNs show high catalytic activities toward both oxygen evolution reaction (OER) and ORR including bifunctional catalytic activities with high catalytic efficiency and long-term durability. Such catalytic materials may be provided as nanoparticles.

The catalyst may be a metal-free catalyst. One example of a metal-free catalyst, which is especially suitable or ORR, is trioxotriangulene. Trioxotriangulene (TOT) is a polycyclic hydrocarbon functionalized with three oxo-groups, and its neutral radical is highly stable due to the delocalization of electronic spin on the whole 25π-electronic system. TOT derivatives also exhibit a four-stage redox ability generating thermodynamically stable polyanionic species, realizing a high performance Li-ion secondary battery. The redox between open-shell neutral radical and close-shell monoanion species occurs at a relatively high potential around 0 V vs. ferrocene/ferrocenium (Fc/Fc⁺), and the redox potential can be flexibly tuned by the substituent groups

### Leaching

The “leaching agent” refers to one or more agent(s) which can be used in leaching process of metals or rare earth metals. Leaching agent may provide one or more redox pair(s), which also may be considered as reactive species. The leaching agents may be provided in an aqueous solution, which is a leaching solution. The leaching solution may contain 0.1-10% (w/w) of the leaching agent(s) and/or leaching agent precursor(s), such as 0.5-5% (w/w), or 1-7% (w/w) or the leaching agent or leaching agent precursor concentration may be in the range of 0.05-0.5 M, for example about 0.1 M. For example for thiourea the concentration may be in the range of 0.5-10% (w/w), such as 1-10% (w/w), 1-3% (w/w), 3-5% (w/w) or 5-10% (w/w).

The leaching agent precursor may be selected from thiourea, halides, such as iodide, such as potassium iodide (KI) or KIO₃ or any other suitable leaching agent. Halide-based leaching agents and thiourea are especially suitable or practically only suitable for leaching precious metals and platinum group metals. The leaching agent is obtainable from a leaching agent precursor, preferably by reacting with reactive oxygen species, such as hydrogen peroxide. Thiourea and halide, such as iodide, based leaching agents are preferably used at acidic conditions, such as at a pH in the range of 0-6, such as 0-4, 2-6, 0-2, 2-4 or 4-6. The pH of the aqueous solution may be adjusted with a pH adjusting agent, such as acid. Preferably weak acids and/or organic acids are used. In one embodiment the leaching agent precursor is provided with one or more weak and/or organic acid(s). Especially citric acid was found suitable with thiourea, even at very low pHs of about 2, even though higher pH up to about 7 may be used. However the pH range for thiourea leaching is conventionally limited with factors such as Fe(III) hydroxide precipitation above pH 3 and sharp increase in reaction kinetics of thiourea oxidation above pH 3.5-4. By using hydrogen peroxide as an oxidant and/or controlled reaction conditions and specific catalytic materials it may be possible to use higher pH ranges. The oxygen reduction was obtained even without strong use of external energy. In addition to thiourea and halide based leaching methods weak acids have been found suitable for leaching rare earth metals. In one example it was found preferable in some cases to adjust the pH with citric acid to 4-6, especially is it would be challenging to obtain fully reversible reactions and/or if a stabilizing agent is not used.

Conventional thiourea oxidation may be carried out by chemical methods of adding H₂O₂ chemical with thiourea to generate formamidine disulfide. However in order to avoid further oxidation of thiourea into non-reversible forms it is challenging to control the chemical based approach as per once certain dosage of H₂O₂ is added, the reaction with thiourea continues until fully used.

The oxidation of thiourea, or other leaching agent or leaching agent precursor, may be controlled accurately and as a feedback to measured properties of the solution, such as redox potential and/or other features describing the oxidation state of thiourea or other leaching agent or precursor, correcting means can be carried out immediately to bring the oxidation reactions to a desired level or state, usually to a predetermined preferred range in respect of one or more measured values. It is possible to avoid overoxidation of thiourea, so that the thiourea is not converted into a form which is not reversible. Therefore it is possible to efficiently utilize thiourea in the leaching reactions, which is desirable in many cases or conditions wherein other leaching agents may not be suitable or are less efficient. It was also found out that sodium sulphite could reduce thiourea consumption and act as an electrolyte in the solution.

The leaching agent may comprise or include thiocyanate, paracetic acid, or amino acids.

In one example the leaching agent and/or reaction solution comprises supercritical carbon dioxide (CO₂). It was found out that it is possible to leach metals by using supercritical carbon dioxide together with hydrogen peroxide, preferably as a main process, but alternatively also as a supporting process. This provides tunability and selectivity to the process. In such case it may not be necessary to react the leaching agent precursor with the formed hydrogen peroxide to form a leaching agent at all or at high amounts. The hydrogen peroxide and/or supercritical carbon dioxide act as the leaching agent(s) and/or leaching agent precursor(s). Such a combination provides solutions involving green chemistry and cost efficiency. Other agents, such as catalytic materials, or methods, such as other methods providing external energy, may be used to supplement and/or control the main process. In one embodiment the leaching agent precursor is supercritical carbon dioxide.

Supercritical carbon dioxide (sCO₂) is a fluid state of carbon dioxide where it is held at or above its critical temperature and critical pressure. Carbon dioxide usually behaves as a gas in air at standard temperature and pressure (STP), or as a solid called dry ice when frozen. If the temperature and pressure are both increased from STP to be at or above the critical point for carbon dioxide, it can adopt properties midway between a gas and a liquid. More specifically, it behaves as a supercritical fluid above its critical temperature (304.25 K, 31.10° C.) and critical pressure (7.39 MPa, 73.9 bar), expanding to fill its container like a gas but with a density like that of a liquid. The viscosity of sCO₂ is very low, and it exhibit diffusivity, which may facilitate the leaching reactions and flow in the system.

In this respect the present application provides a method for recovering metal from metal-containing material by leaching, the method comprising
providing aqueous solution or liquid containing supercritical carbon dioxide, for example as a leaching agent precursor,
providing one or more source(s) of external energy comprising electric current provided with one or more non-metallic electrode(s),
treating the aqueous solution or liquid containing supercritical carbon dioxide with the external energy to form hydrogen peroxide from oxygen in the aqueous solution or liquid, preferably by electrochemical oxygen reduction,
optionally reacting leaching agent precursor with the formed hydrogen peroxide to form a leaching agent and to obtain a leaching solution,
providing metal-containing material,
reacting the metal-containing material with the hydrogen peroxide and supercritical carbon dioxide, optionally with the leaching solution, to obtain soluble metal complexes, and
recovering the soluble metal complexes.

Supercritical carbon dioxide has a low toxicity and it is environmentally benign and easily recyclable. The relatively low temperature of the process and the stability of carbon dioxide also allows most compounds to be extracted with little damage or denaturing. Solubility of many extractable compounds in carbon dioxide varies with pressure allowing selective extractions. Therefore it is possible to adjust the pressure in the reactor to selectively leach a desired metal. In such case the reactor may be equipped with means for controlling the pressure in the reactor, and preferably means for detecting pressure in the reactor. Also these means may be operatively connected to control unit. The control unit may be arranged to maintain the pressure in the reactor in a predetermined range, which may be according to a metal or interest, and may vary during the procedure especially if there are more than one metals of interest, as a feedback to measured pressure. Molecular water solvated in liquid and supercritical CO₂ is quite reactive towards minerals, such as iron and silicate mineral surfaces.

It is possible to synthesize the carbon dioxide in situ or on site. Carbon dioxide may be captured directly from the ambient air. The air may flow through a filter wherein the carbon dioxide is recovered. A liquid solvent, such as amine-based or caustic solvent, is used to absorb CO₂ from the air. For example sodium hydroxide may be reacted with CO₂ to precipitate stable sodium carbonate. This carbonate is heated to produce a highly pure gaseous CO₂ stream. Sodium hydroxide may be recycled from sodium carbonate in a process of causticizing. Alternatively, the CO₂ may be used to bind to solid sorbent in the process of chemisorption. The CO₂ may be then desorbed from the solid by using heat and vacuum.

Carbon dioxide may be provided also as a separate chemical, such as the form of gas, liquid or solid. In one example the carbon dioxide is provided in the form of dry ice. Carbon dioxide may be formed into supercritical carbon dioxide by using suitable container(s) and device(s), such as devices including one or more pump(s), sealed container(s), means for adjusting and/or controlling temperature, and the like necessary means for obtaining desired supercritical state of carbon dioxide from starting material. The device or device setup may be controllable, such as including one or more control unit(s) operatively connected to the controllable device parts.

When using supercritical carbon dioxide an open reactor cannot be used but the reactor shall be closed and sealed reactor, such as airproof reactor, preferably arranged to tolerate a pressure of the least 7.5 MPa. The reactor is preferably temperature-controlled, so that high enough temperature may be obtained to enable the conditions required to obtain the supercritical carbon dioxide. The reactor may comprise means for adjusting temperature, such as one or more heating and/or cooling means.

Supercritical carbon dioxide is not prone to explode or toxic, so it is safe to store, transport, handle and use. Relatively low temperature and pressure are required to obtain the supercritical state, which further enhances safety and saves energy.

Increasing the pressure and temperature of supercritical carbon dioxide actually adjusts the polarity of the carbon dioxide molecule. Carbon dioxide is normally non-polar but under increasing pressure and temperature in the supercritical state, it becomes more polar. Historically carbon dioxide was considered as a nonpolar solvent, primarily because of its low dielectric constant and zero molecular dipole moment. It may however act as a quadrupolar solvent because of its significant quadrupole moment. Carbon dioxide may act as both a weak Lewis acid and Lewis base, and it can participate in conventional or nonconventional hydrogen-bonding interactions.

In the leaching the system and process can be easily controlled by adjusting the states of gas and liquid, for example by adjusting and controlling pressure and/or temperature. For example the materials may be leached first in the liquid carbon dioxide and subsequently recover by lowering pressure so that the carbon dioxide is transformed back to gaseous form. The metals may be then recovered, and the carbon dioxide may be recycled. Carbon dioxide may be used to enhance the effect of radical species or hydrogen peroxide obtained with any suitable methods disclosed herein, and to enhance the selectivity of reactions.

However it was noticed that oxidation by hydrogen peroxide may not be initiated at any conditions, even if external energy is provided to the reaction. This problem may be especially relevant to iodine oxidation, or in general reactions including iodine, especially at neutral pHs. It was found out that providing acid, such as organic acid citric acid, cause the reaction to initiate

With the leaching agent precursor or leaching agent, especially thiourea, it is also possible to include ferric ions, for example in combination with a complexing agent such as di- and tri-carboxylic acid, phosphoric acid, phosphate salt, thiocyanate, fluoride, fluosilicic acid, fluosilicate salt, EDTA or EDTA salt, or a combination thereof. The complex of ferric ions and complexing agent, with the organic acid such as citric acid, may slow down or stabilize the oxidation of leaching agent precursor.

The leaching agent precursor may contain iodine material, such as iodide material and/or iodate material. Iodide material comprises compounds capable of forming iodide in an aqueous solution, such as triiodide. Iodide material may comprise iodide salt, such as potassium iodide KI or potassium iodate KIO₃.

In one example potassium iodide (KI) is provided as a leaching agent precursor. When aqueous solution of potassium iodide is treated with the external energy, oxidation occurs and I⁻ ions are oxidized by the generated radicals to give I₂. The excess of I⁻ ions present in solution react with I₂ to form I₃⁻. Therefore in the reactions (7-11) iodide ion (I⁻) reacts with hydrogen peroxide (H₂O₂) to form a triiodide (I₃⁻) ion. The amounts of I₃⁻ ions can be quantified by UV spectrophotometer at about 350 nm. The concentration of H₂O₂ generated in the process can be determined using iodometric method. In one example the leaching agent comprises triiodide.

H₂O₂+2I⁻+2H⁺→I₂+2H₂O (7)

.OH+I⁻→OH⁻+I (8)

I+I⁻→I₂⁻ (9)

2I₂⁻→I₂+2I⁻ (10)

I₂+I⁻→I₃⁻ (11)

Further, the .OH radicals may oxidize iodide into triiodide I₃⁻:

2.OH+3I⁻→2OH⁻+I₃⁻ (12)

Therefore, it is possible to controllably obtain compounds and adjust the concentration thereof in a solution by controlling the function of one or more source(s) of external energy. It is possible to obtain information from the solution, for example by providing one or more pH and/or redox meter(s) and/or measuring device(s) based on UV spectroscopy in the solution, preferably operating in continuous mode, which may be used to obtain measurement data. The data may be used for arranging a feedback control circuit, which may be arranged to control the function, of the one or more source(s) of external energy. One or more of such controlling actions may be carried out to obtain a desired reaction rate and/or to obtain a desired and/or optimal concentration of leaching agent(s) in the solution, such as concentration of redox pair(s), for example I₂⁻/I₃⁻. In such way it is possible to obtain an optimal chemical concentration, consumption and/or solubilization rate to release the desired metal(s) or rare earth metal(s) from the raw material.

The method comprises reacting the metal-containing material with the leaching solution to obtain soluble metal complexes, and recovering the soluble metal complexes

For example, gold may be released and solubilized from raw material by using I⁻ and I₃⁻ present in the solution into AuI₂⁻ and AuI₄⁻ with the reactions 13-17. The same principle may be applied to other metals and rare earth metals as well.

Au+2I⁻→AuI₂⁻+e⁻ (13)

Au+4I⁻→AuI₄⁻+3e⁻ (14)

I₃⁻+2e⁻→3I⁻ (15)

Iodine-iodide reactions in leaching of gold may be presented with reactions 16 and 17.

2Au+I₃⁻+I⁻→2AuI₂⁻ (16)

2Au+3I₃⁻→2AuI₄⁻+I⁻ (17)

In one example silver is leached according to the principle disclosed in previous. Also other metals or rare earth metals discussed herein may be leached by using these or analogous reactions.

In one example an additional reactive ligand is provided for binding the metal of interest. Hydrogen peroxide or other suitable reactive species may act as an oxidant. One example of such a ligand is pyridine-4-thiol (4-PSH), for example in organic solution such as dimethylformamide. Dissolution of Au proceeds through several elementary steps: isomerization of 4-PSH to pyridine-4-thione (4-PS), coordination with Au⁰, and then oxidation of the Au⁰ thione species to Au^{I} simultaneously with oxidation of free pyridine thione to elemental sulfur and further to sulfuric acid. The final dissolution product is a Au^{I} complex bearing two 4-PS ligands and SO₄²⁻ as a counterion. The ligand is crucial as it assists the oxidation process and stabilizes and solubilizes the formed Au cations.

The leaching agent precursor may also contain halogen material, such as bromine material or chlorine material. Halogen material may be added as a sodium salt or a potassium salt. Examples of halogen material include chloride salt and bromide salts, such as potassium chloride and/or sodium chloride or potassium bromide and/or sodium bromide. The leaching agent precursor may also contain boric compound, such as boric acid. The obtained redox pair may be Br₂ and Br− when bromine material is used and Cl₂ and Cl⁻ when chlorine material is used.

In general, the leaching agent precursor may comprise one or more agent(s) selected from halogens and pseudo-halogens, metal complexes, organic metal-free redox pairs, interhalogen molecules, cobalt complexes and transition metal redox pairs.

Examples of halogens and pseudo-halogens include 1, Cl, Br, F and polyatomic analogues of halogens for example with cyano group, such as redox pairs I⁻ and I₃⁻, Cl₂ and Cl⁻, Br₂ and Br⁻, Br⁻ and Br₃⁻, and several pseudo-halogen redox mediators such as redox pairs SeCN—/(SeCN)³⁻ and SCN/(SCN)³⁻.

Examples of metal complexes include a Co(II/III) tris(bipyridyl) redox pair, Ni(III)/(IV) bis(dicarbollide) and [Cu(dmp)2]^{1+/2+} and a ferrocene/ferrocenium redox pair.

Examples of organic metal-free redox pairs include the thiolate and thiourea based redox mediators such as thiolate/disulfide (T⁻/T₂) redox pair, 123 2-mercapto-5-methyl-1,3,4-thiadiazole and its disulfide dimer (McMT⁻/BMT) and tetramethyl formaminium disulfide/tetramethylthiourea (TMTU/TMFDS²⁺); and tetramethylpiperidin-N-oxyl (TEMPO) and 2-azaadamantan-N-oxyl.

Interhalogen molecules may be based on IBr²⁻ and I₂B^{r-}.

Examples of cobalt complexes include Co(II/III) tris(bipyridyl) redox pair, [Cu(dmp)₂]^{1+/2+}, ferrocene/ferrocenium redox pair, cobalt complexes including terpyridine, bipyridine, and phenanthroline, based on [Co(dtb)3]^{2+/3+}.

The leaching agent precursor may comprise one or more amino acid(s), such as glycine.

It may be necessary to adjust the pH of the solution to obtain optimal conditions for forming reactive species with the external energy. For example the method may comprise lowering the pH of the aqueous solution, for example by adding acid, such as weak acid and/or organic acid. The pH may be lowered to 6, 5, 4, 3 or 2 or below, such as to a range of 0-6, 0-5, 0-4, 0-3 or 0-2. The acid may be for example citric acid, hydrochloric acid or other suitable acid. It may be desired to use organic acid which are more environmental friendly compared to inorganic acids. Examples of suitable organic acids include carboxylic acids such as lactic acid, acetic acid, formic acid, citric acid, oxalic acid, uric acid, malic acid, butyric acid, salicylic acid, acetyl salicylic acid, and phenols, preferably acetic acid and/or citric acid.

The method may also comprise providing one or more chemical oxidant(s), such as hypochlorite, hydrogen peroxide, persulfate such as potassium monopersulfate, potassium persulfate, or sodium persulfate, ozone, haloalkane(s), such as chloroalkane(s), for example carbon tetrachloride (CCl₄), chloroform (CHCl₃) or dichloromethane (CH₂Cl₂), or other materials preferably capable of oxidizing iodide to iodine or facilitating it, to the aqueous solution. The chemical oxidant may also be treated with the external energy. Haloalkanes may be added to provide chlorine radicals Cl. when treated with the external energy. Especially chloroalkanes may be used for improving the efficacy of acoustic cavitation or other reactions utilizing external energy. The chlorine radicals also take part in the desired reactions, such as the oxidation process, and intensify the rates. For example chlorine radicals may be formed to obtain iodide redox pairs.

Ozone may be provided by providing a source of ozone, such as an ozone generator, and providing ozone to the aqueous solution with the source of ozone, such as ozone generator. It is possible to facilitate the initiation of the hydrogen peroxide formation reaction by adding ozone or other radical-forming agent, and the process may be thereafter run only or mainly using the external energy, as described herein. The chemical oxidant, such as ozone, or chlorine radicals, may be provided at an initiation phase, or additionally at a later phase, if required, preferably for a relatively short time period, such as for 1 second to 10 minutes, for example 1-300 seconds or 1-60 seconds. After the reaction has been initiated or started, it can be maintained using the external energy as described herein.

When ozone is used with potassium iodide the following reactions (18, 19) may occur.

2KI+O₃+H₂O→I₂+O₂+2KOH (18)

I₂+I⁻→I₃⁻ (19)

When the solution contains excess potassium iodide the iodine reacts with iodide ion to produce triiodide ion. With the ozone the obtained I⁻ and I₃⁻ will oxidize gold with the principles presented in reactions 14-18. It is also possible to provide potassium iodate (KIO₃) or iodine (I) at the initiation phase to achieve a quick start.

Gold forms a complex with bromide and chloride as presented in reactions 20 and 21. With the compounds obtained with the previously presented reactions by using sodium chloride and/or hypochlorite it is possible to obtain gold leaching and gold complex producing compound trichloride ion Cl₃⁻. To maintain the stability of the gold chloride complex it is necessary to control the pH accurately as the gold leaching rate slows down at pH 1.5-4, so it may be preferable to adjust the pH below 3 to obtain preferable conditions to obtain desired trichloride ion concentration.

2Au+3Br₂+2Br→2(AuBr₄)⁻ (20)

2Au+3Cl₂+2Cl⁻→2(AuCl₄)⁻ (21)

If the redox potential of the solution lowers too much, the complex will dissociate, and the gold will precipitate. This is not desired at the leaching phase. Therefore the solution must have an adequate concentration of free oxidant, which may comprise chlorine, bromine or iodine when halogens are used. In such case the method may comprise providing chemical oxidant. Instead of chlorine also hypochlorite can be used and therefore the concentration of bromine and/or iodine in the solution can be lowered. The equilibrium of the complex can be adjusted by adjusting the pH of the solution, the concentration of the halide or other chemical oxidant, and/or redox potential.

In addition to the leaching of precious metals, also other metals are solubilized to the leaching solution, such as copper and iron. For example copper will form a CuI₂ complex which is not stabile and will be reduced to CuI according to reaction 22.

2Cu₂→2CuI ↓+I₂↓ (22)

The oxidation of iodine may be enhanced, if necessary, by adding organic chlorine compound to the aqueous solution, such as CCl₄, wherein Cl. radicals and Cl₂ will be released in large amounts thus increasing the oxidation rate of iodide. Alternatively chloral hydrate CCl₃CH(OH)₂ may be used for enhancing the oxidation of iodide.

To maintain stable optimal reactions and reaction rate(s) the acid-base equilibrium (pH) and redox potential (Eh) may be controlled and/or adjusted. These may be illustrated by using a Pourbaix diagram. The formation of gold complexes AuI₂⁻ and AuI₄⁻ takes place when the solution has a suitable concentration of I⁻ and 13 and the pH and the redox potential are in a suitable range. The pH of an aqueous KI solution is maintained at a neutral pH range during the solubilization phase. For example the stability of AuI₂⁻ gold iodide complex weakens when the pH rises close to 12, and a stabile range can be selected at pH 5-8. The redox potential, more particularly voltage or Eh value, can be adjusted with the ultrasound, and optionally also with the source of chemical oxidant(s), such as ozone, especially with an ozone generator. The stabile voltage range will narrow when the pH rises.

For a gold complex optimal stabilization can be achieved when the Eh voltage is adjusted to the range of 0.5-1.1 V, such as about 0.7 V.

The method may comprise adjusting the pH of the aqueous solution to a desire range, such as in the range of 3-10, such as in the range of 4-8 may be used, or in the range of 5-8. The desired range may be a range wherein the formation of the metal complex or the rare earth metal complex is most optimal and/or stable. The pH may be adjusted by adding one or more pH adjusting agent, which may be acid or base, for example weak acid or base, such as citric acid or oxalic acid, to the aqueous solution. The pH may be also buffered by providing one or more buffering agent(s). The pH of the solution may be monitored by using one or more pH meter(s), and as a feedback an automated system may be configured to carry out one or more actions to adjust the pH of the solution to obtain a desired pH or a pH in the desired range.

The pH may be adjusted by treating the aqueous solution with ultrasound to form reactive species sonochemically from water or aqueous solution, for example by using proton exchange membrane (PEM), anion exchange membrane (AEM) or bipolar membrane (BPM), to generate H⁺ and/or OH⁻ ions. It is possible to separate the obtained H⁺ and/or OH⁻ ions by using such membranes, and then utilize the separated ions for adjusting the pH. Formation of undesired gases or other reactions caused by electron transfer can be avoided. Further, there is no need to add any additional acidic or basic chemicals. The system may comprise means for separating H⁺ and/or OH⁻ ions, preferably by using one or more of said membrane(s), and for dosing said separated H⁺ and/or OH⁻ ions to the aqueous solution to obtain a desired pH. In this way there is no need to add any additional reagent(s) to the aqueous solution, which makes the system and method simpler, more economical and the use of possibly harmful chemicals can be avoided.

With H⁺ ions it is possible to lower the pH of the solution, for example to stabilize the formation of the complexes. With OH⁻ ions it is possible to raise the pH of the solution. In the precipitation phase it is also possible to raise or lower the pH to a desired value, and/or after the precipitation it is possible to change the pH back to the original value or range which would be optimal for the solubilization.

The method may comprise adding mixture of oxygen and argon to the aqueous solution. This was found out to enhance the formation of reactive species, such as hydrogen peroxide, especially when compared to oxygen or argon alone. For example too high oxygen content may decrease the formation of hydrogen peroxide. The oxygen-argon mixture may be provided as containing 20-30% (v/v) oxygen and 70-80% (v/v) argon.

In one embodiment the method comprises measuring or determining the concentration of the leaching agent in the aqueous solution, and as a feedback to the measured or determined level, if necessary, adjusting the one or more source(s) of external energy to obtain a desired level of reactions, such as the oxygen reduction reactions, to maintain the formation and/or amount of the leaching agent at a predetermined range. Analogously it is possible to measure or determine the level of leaching agent precursor, or the level of hydrogel peroxide and/or other reactive species, or combination of two or more of the above, and as a feedback to the measured or determined level carrying out the adjusting actions.

The leaching may be carried out for a time period required to obtain desired, such as full or substantially full leaching of the metal(s) of interest. This may depend on the starting material, preprocessing degree of the starting material, the content of recoverable metal(s) in the starting material, concentrations, reaction conditions, device setup, desired chemicals and/or device setup and/or on several other factors. Therefore the leaching time may vary, and may be for example from 10 minutes to 10 hours, such as in the range of 0.5-8 hours, even in the range of 15-120 minutes.

### Recovery and Post-Processing

When the desired metal is solubilized into the leaching solution and a pregnant solution is obtained, the metal may be recovered from the solution. The pregnant solution may be conveyed to another container or place to be treated to recover the metal. The metal may be also recovered in the same container, i.e. the reactor, wherein the leaching has occurred.

The pregnant solution may be post-processed, for example to remove non-desired material, such as residual metals which are not in a soluble form. This may be carried out by filtrating the solution to remove non-soluble material. This will help decreasing the chemical consumption in the recovery phase, for example in a precipitation, saving money and enhancing the quality of the final product.

The treated material may be removed from the reactor when the metal(s) of interest is/are solubilized. This may be monitored by measuring one or more soluble chemical(s) or suspended solid(s) spectrophotometrically or using radio frequency technology from the aqueous solution. It is also possible to treat material such as circuit boards, connectors or the like wherein the metal of interest, such as gold, is as a coating on the material. When it is detected that the coating has been solubilized, the treated material may be removed from the solution so that the metal(s) below the coating is/are not solubilized, such as copper or iron. Therefore the leaching may be carried out only until the metal of interest has been solubilized, or substantially solubilized, for example 90% (w/w), 95% (w/w) or 99% (w/w). The leaching and/or the subsequent recovery step lay be carried out continuously or as a batch process.

In one example the pregnant solution is conveyed to a second container, or to a further container, such as third or fourth container, for example via one or more tube(s) and/or aperture(s) arranged between the reactor and the second and/or further container(s). The second container, or one or more container(s), connected to the reactor may comprise means for recovering metal. The treated aqueous solution is arranged to be conveyed to the container. This may be facilitated by using one or more pump(s), mixer(s) or other devices arranged to convey the aqueous solution into and/or from the reactor.

Recovering the soluble metal complexes may comprise using scavenger material, as disclosed herein, but any suitable method may be used instead or additionally, such as electrowinning, precipitation, cementation or loading/adsorption onto activated carbon and/or ion exchange resins, or a combination thereof. The second or further container may contain means for carrying out any of said recovering method. The recovering may be carried out for a time period required to recover all or substantially all of the metal(s) of interest.

Electrowinning, also called electroextraction, refers to electrodeposition of leached metals from solution. A current is passed from an inert anode through the leaching solution containing the metal so that the metal is extracted as it is deposited in an electroplating process onto the cathode. Therefore in electrowinning the means for recovering metal may comprise anode, cathode and a power source connected to the anode and cathode.

The method may comprise precipitating the metal, for example by providing one or more precipitating agent(s), such as L-ascorbic acid, D-(−)-isoascorbic acid, isoascorbic acid, oxalate, glucose, sodium borohydride or hydrazine. The means for recovering metal may comprise means for providing one or more precipitating agent(s), activated carbon and/or ion exchange resin(s), such as one or more container(s) for the precipitating agent(s), one or more tuber(s) and/or valve(s) for dosing the agent(s) from the container, one or more actuator(s) for operating the valve(s), wherein the actuator(s) may be operatively connected to one or more controlling means.

The method may further comprise recycling the leaching solution back to the treatment after recovering the metal.

### Scavenger Materials

The use of specific leaching agent(s) and/or other reagents may make the recovery of the leached metals challenging. For example it may be necessary to adjust the pH or other reagent content or reaction conditions to be able to apply conventional recovery methods. For example when halide-based leaching agents and thiourea are used, such problems may arise. Therefore it may be necessary to use specific scavenger materials or other activated materials to bind and recover the leached metals, especially directly from the leaching solution and preferably without using further reagents or solutions or adjustment of the reaction conditions. The scavenger material may be able to selectively bind the metal of interest, preferably in a reversible way so that the metal can be removed, for example eluted at suitable conditions and/or with suitable elution solution, from the scavenger material and further processed, such as concentrated and/or collected. The scavenger material therefore comprises selective chemical functionality. “Selective” means that the functionality, such as ability to bind, is not similar towards all compounds.

Such scavenger materials may be ionic scavenger materials. Recovering by using scavenger materials is fast compared to conventional methods, such as electrowinning. For example when recovering gold it may take 8 hours or more to recover the gold at the cathode by electrowinning, and still part of the gold remains in the solution, such as about 5 ppm. On the other hand when using scavenger materials the solution may be flowed though the material several times in a very short time resulting in better recovery without using electricity.

In one embodiment the means for recovering metal complexes comprises surface-treated or surface-activated scavenger material able to selectively bind the metal complex(es). Scavenger material as used herein refers to material including a reactive compound which can bind the metal or metal complex of interest. Preferably the scavenger material can bind the metal or metal complex from a solution, such as the leaching solution or its derivative. The scavenger material may be also called as absorber or absorbing material, or binder or binding material, and it may be called also in the present context as metal scavengers or metal scavenger materials. Such material may specifically remove the metal(s), preferably metal(s) of interest, from a system, such as a solution. The metal(s) may be removed from the scavenger material to recover the bound metals. The removing may be carried out by eluting with a suitable liquid, by mechanical methods, or by other suitable methods and/or means. The scavenger material may be disintegrated to release the bound metal(s), such as by mechanically disintegrating the material, for example by grinding, abrading and/or the like methods. Scavenger materials may be based on functionalized materials, such as plastics or the like, which may be in the form of sheets, bars, powder, granules, beads, fibers or filters. Such specific forms may be applied to different applications, different solutions and/or compositions, different metals and/or different means for recovering the metals(s).

The scavenger material may comprise or consist of thermoplastic polymer, or it may comprise a polymeric base or body comprising or consisting of thermoplastic polymer. Examples of such polymers include polyamide, such as polyamide 12 (Nylon 12), and polypropylene, such as polypropylene 1 (PP1). The polymer may be formulated into a desired shape of scavenger material. The means for recovering metal complexes may comprise surface-treated or surface-activated scavenger material in a form of a sheet, a film, a membrane, a bar, powder, a granule, a bead, a fiber and/or a filter.

The scavenger material may be provided in a casing or other support structure, for example in a cartridge, a cylinder, an open container or the like structure arranged to hold the scavenger material. The casing may be a flow-through casing. Such a casing allows flow of liquid through the casing so that the liquid will be in contact with the scavenger material inside the casing. The casing may have one or more apertures to allow flow of liquid, and/or it may be one or more inlet(s) and/or one or more outlet(s). The casing may be perforated. The casing may be arranged to be installed to a flow path of the liquid, for example to a location wherein the leaching solution is pumped or otherwise conveyed to enable flow of the solution to the casing, more particularly to the scavenger material. The casing may also include a filter or membrane, such as a semipermeable membrane, which may be located at the one or more apertures, such as at an inlet and/or at an outlet. Therefore it is possible to obtain a higher pressure inside the casing, for example by using a pump, which may enhance the effect of the scavenger material inside the casing. Such filter or membranes may also se used to recover or exclude material with certain particle size or diameter. It is also possible to control the pressure inside the casing by adjusting the size of apertures. Therefore the pressure may be adjusted or adjustable inside the casing, for example by controlling the pressure provided by the pump, controlling the size of the apertures, for example by one or more movable parts arranged to limit the aperture(s), or by other means having impact to the pressure. The pump, any actuator(s) connected to any movable parts, and/or other means may be operatively connected to the control unit. They may be arranged to be controlled to obtain a desired pressure, flow and/or other variable, preferably to maintain such a variable in a predetermined range.

The casing may be dipped to the solution, or arranged to be dipped or otherwise contacted with the solution. The casing may be applied to the solution for a suitable time period to bind metal complexes to the scavenger material, and it may be removed from the solution for further processing, for example to elute or otherwise recover the metal from the scavenger material, for example at another location. The scavenger material may be provided to the leaching solution in analogous way without a casing, for example when in form of sheet, beads, filter or other suitable form, and/or removed from the solution.

The casing may be arranged to be opened and closed, so that the scavenger material may be inserted and/or removed. For example after the recover of metal from the leaching solution, the scavenger material containing the metal may be removed from the casing and treated to separate the metal from the material. Also new scavenger material and/or reactivated scavenger material may be inserted into the casing.

In one embodiment the means for recovering metal complexes comprises scavenger material comprising carbon nanomaterials, such as carbon nanotubes, carbon fibers, which may be carbon nanofibers, or carbon nanobuds. These may be the surface-treated or surface-activated scavenger materials or the surface-treated or surface-activated scavenger materials may comprise the carbon nanomaterials.

The scavenger materials may be surface-treated, surface-activated or doped, for example in a similar way as explained for the electrodes.

The scavenger material may be surface-treated or surface-activated by plasma and/or laser. For example polyamide or polypropylene based materials may be surface treated, so that they are able to selectively bind the metal(s) or complexe(es) thereof directly from a solution, such as a saturated/pregnant solution. It is not necessary to modify the pregnant solution any way. These thermoplastic polymer materials, such as polyamide 12, are very inexpensive materials, readily available and can be used at acidic conditions.

The polymeric scavenger material may be provided in desired form, such as porous form, in a form of sheet or the like as described herein and/or comprising plurality of (interconnected) particles, for example obtained by additive manufacturing. This material can then be treated with plasma. For example the material in the desired form may be treated with plasma in vacuum, such as in a vacuum chamber. An amplified radio frequency signal is fed to a coil around the chamber, such as copper coil, thus causing plasma glow in the chamber. The signal may be provided by a controllable RF amplifier which can provide desired frequency, pulse form and amplitude to the coil. Gas such as oxygen or nitrogen may be fed to enhance the obtained surface treatment. The conformal plasma penetrates into the (porous) material and therefore is able to transform all the surfaces of the material, especially inside porous material, into functional form. Such activation arrangement may be integrated as a part of a flow reactor in the system setup, for example by providing a vacuum pump to a filter casing and providing a coil around the casing to provide the plasma in the casing. Therefore the surface treatment of the scavenger material can be repeated when necessary.

The scavenger material may be provided in a flow-through filter, for example provided in a casing, as a porous filter material, or in other way as described herein. The filter may be designed to be placed to a flow path of the leaching solution, which may depend on the device or setup. For example the setup may contain a pump arranged to pump and/or circulate the leaching solution, for example via to tube, wherein the filter is arranged to be placed or placed to the flow path of the pumped solution, for example into the tube. The filter may contain a plurality of scavenger material units, such as granules, beads, powder particles, fibers, filter(s) and/or the like.

If the scavenger material is provided as material particles having relatively small dimensions, such as powder, small beads or other particles having a diameter less than 1 mm, or less than 0.1 mm, such as an average particle diameter in the range of 10-200 μm, such as 1-100 μm, it is possible to obtain a very high surface area in a small volume. However, it may be challenging to handle the material, to provide suitable form of material enabling adequate flow through of solution and/or recovery of the material. This would require a filtration system to recover the particles, so the material may be packed in a suitable filter casing, such as a flow-through casing. To obtain scavenger material having a large surface area, in similar way when small particles are used, but also good flow-through properties, it is also possible to use additive manufacturing (3D printing) to prepare scavenger material in a form of interconnected particles. The particles are therefore in a form of a column or a mesh, which may be a single object but provides porosity which can enable high flow-through of solution.

Additive manufacturing may be used to obtain complex 3D structure of scavenger material or material comprising the scavenger material, which provide desired mechanical properties, such as elasticity, flexibility, rigidity, and the like, or materials combining the properties or having different parts exhibiting different properties. The mechanical properties may also facilitate assembly of a final product, which may comprise scavenger material packed in a casing. The structures may also enable high flow-through of aqueous solution. The scavenger material may comprise or be based on plastic polymer(s), such as polyamide or derivative thereof. The scavenger material, preferably fully or partly obtained by additive manufacturing, may comprise one or more types of parts or structures, such as film, sheet, bar or the like, which may be multi-layered, and/or which may include fibers, interlayer structures (spacers), grooves, ridges, pores, apertures and the like, or combinations thereof. Elastic sheets or films may be rolled or otherwise folded into forms which may be packed in a casing. Such structures provide large surface area and good flow properties for the solution to be treated. The material may contain elastic hinge parts which facilitate the folding and assembly. The initial form may be continuous, i.e. uninterrupted. After forming by additive manufacturing, the initial form may be surface treated or surface-activated with the methods disclosed herein, for example on a conveyor or if the material sheet or film is unrolled from a first roll, surface-treated or surface-activated, and preferably then rolled into a second roll. Because of the continuous structure the scavenger material may be activated easily. For example, if plasma activation is integrated in a casing, the plasma may be conveyed into the 3D structure, which may be porous, so it would not be necessary to disassemble the filter casing to reactivate the material.

The scavenger material may be formed into a surface-activated form in the process of additive manufacturing. Such material contains a chemical functionality, so that is can bind one or more metal(s) or metal complex(es), especially from a solution. Such surface activation of chemical functionality may be obtained without post-processing, for example by adjusting the manufacturing parameters in such way that the polymer is melted only partly at the surface to provide the surface-activated portion. For example when using laser for additive manufacturing, the power of laser of 15-80%, such as 30-70%, of the full power may be used to form the active portions of the material. When the material originally present as fine powder is only partly melted, functionalities such as ion exchange functionality or other binding functionality can be obtained. The active surface may comprise one or more of active compound(s) providing selective chemical functionality, and/or the polymer itself may be such an active compound. The selectivity means that only one or more desired compound(s) can bind or react with the active compound(s), such as the metal complex(es) of interest.

In one embodiment the means for recovering metal complexes comprises scavenger material, such as surface activated scavenger material, obtained by additive manufacturing and comprising selective chemical functionality. Two or more of scavenger materials with different selectivity, such as selectivity for different metal complexes, may be provided. This enables separating and recovering different metals, and preferably further processing them in separate processes.

American Society for Testing and Materials (ASTM) group “ASTM F42—Additive Manufacturing”, has formulated a set of standards that classify the range of Additive Manufacturing processes into 7 categories. These include VAT photopolymerization, material jetting, binder jetting, material extrusion, powder bed fusion, sheet lamination and directed energy deposition. One or more of these methods may be utilized, depending on the desired final product and used material(s). However if the material is based on plastic polymers, it may limit the useful methods.

Additive manufacturing may be used to prepare composite materials, such as nanocomposite materials. Such materials may be composites of two or more materials disclosed herein, for example the hybrid materials, the doped, coated and/or deposited materials, functionalized materials and/or other materials and combinations thereof. In one example the nanocomposite materials comprise carbon-based materials, such as carbon nanotubes or graphene and derivatives thereof, for example with polybutylene terephthalate (PBT). Electrically and thermally conductive polymer nanocomposites can be obtained. Such composite materials may be printed with commercially available 3D printers, which makers the manufacture thereof inexpensive and relatively simple. Therefore low-cost functional objects may be obtained with high conductivity, mechanical properties and other properties.

It is possible also to use carbon nanomaterials, such as carbon nanotubes or graphene-based conductive materials as raw materials for 3D printing composite material, such as nanocomposites, which are useful in the present scavenger materials.

When spacers or the like intermediate parts between sheet, films or the like parts providing large surface areas are used, the mixing, cycling and reacting of the solution in the process is enhanced. Also other porous structures or surface shapes facilitate these functions. Efficient mixing has an impact to the thickness of boundary layer formed by the solution. When the boundary layer is as thin as possible, the polarization effect is reduced as matter transfer is enhanced. The spacers should enhance the flow and provide mechanical support. The spacer should be in contact with the sheets or films as little as possible. Such structures can be effectively obtained by using additive manufacturing. Especially spiral, fiber and framing modules, which may be useful in the present methods, are difficult to manufacture with conventional methods. It is possible to prepare for example spacer structures which comprise several layers. The spacers may be woven, or formed as woven-like structures, for example including a plurality of interconnected fibers. Such spacers enable good flow of solution and consume less energy.

The scavenger material may be provided in a form of a porous body obtained by additive manufacturing comprising a plurality of interconnected polymeric particles having an average particle diameter in the range of 10-200 μm, such as 1-100 μm. The porous body may have a porosity in the range of 10-70%, such as 20-70%, defined as volume of voids over total volume of the body. The scavenger material may have functionalities obtained by surface-treatment and/or doping or other treatment disclosed herein, so that the scavenger material may comprise one or more active component. The polymer may be the active component. The active component may be an ion exchanger, a member of a group of phosphoric and phosphonic acids, a member of a group of transition metals.

Scavenger material may be functionalized by using suitable treatment technology, such as plasma or laser treatment, for example low pressure air plasma treatment, which may take up to three hours, such as 0.5-3 h. The surface of the material is turned into porous and the material may obtain functional properties, such as ion exchange properties, absorption properties or the like properties, which can bind metal complexes from a solution. The material which may be functionalized in such way may include polymeric materials such as discussed herein, for example polyamides or polypropylenes, for example in a form of a sheet, a film, a bar, powder, granules, beads and the like objects and structures. The functionalized objects may be used for preparing devices such as filters or filter structures. For example two or more sheets may be combined as a stacked structure having a gap between each sheet, a film may be rolled into a roll having a gap between each layer, layered structures may be prepared from perforated porous surface-treated or surface-activated sheets, films, fibers, membranes or the like. Filter structures with high throughput flow properties can be obtained. This enables mass production of scavenger materials or devices. Alternatively the material may be treated on a moving belt in the form of power, granules, chips, or other suitable ices or forms, and packed into a suitable filter cartridge or casing. Also the stacked, rolled and/or otherwise combined structures may be packed in filter cartridges or casings, or supported with other a suitable support structures, so that filters, even with standard dimensions, are obtained an can be easily inserted into device setups.

It is possible to remove the recovered metals, such as gold or other precious metals from said objects and structures by mechanically abrading, cutting, or blowing the materials, or by using plasma, ultrasound, laser or the like, or by eluting with a suitable solution which is able to release the metals from the material. It is also possible to burn the scavenger material containing the recovered metal so that only the metal, such as gold, and ashes remain, and the metal can be further recovered. This option can be used especially if the scavenger material is in a form of fibers or other thin structure or form, and/or if inexpensive materials are used, such as plastic polymers, for example polyamide or polypropylene. In such case there would not be need to use any chemicals for eluting the metal, the process would be simpler and less solid waste would remain.

### Device Setup

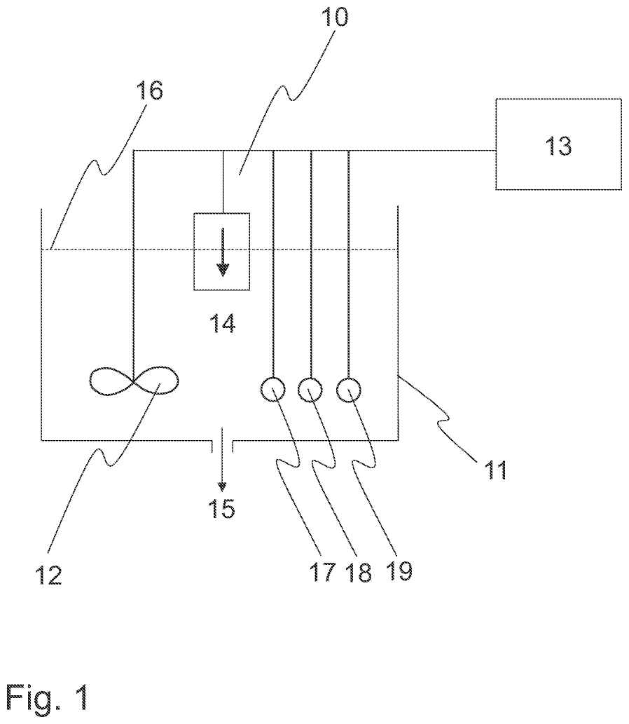

The method may be carried out with the device disclosed herein. The device may be a device setup, or a system, which terms may be used interchangeably. The device may comprise a reactor 11 arranged to receive metal-containing material and aqueous solution, for example separate or in combination, the device comprising one or more source(s) of external energy 10 arranged to provide external energy to the liquid 14, such as aqueous solution, in the reactor 11 to obtain oxygen reduction reaction to form hydrogen peroxide. This may be arranged to be carried out to form reactive species, such hydrogen peroxide, capable of reacting with the leaching agent precursor to form a leaching agent and to obtain a leaching solution. The source of external energy 10 may be a device, such as electrical device and/or power source or means connected to a power source, which is positioned or arranged to provide the energy to the reactor or to a solution in the reactor. The device may be operatively connected to the one or more control unit(s) 13, and it may be arranged to be controlled by the control unit(s). The control unit may be a separate control unit which may be at a different location, as shown in FIG. 1, or it may be embedded in the device acting as the source of energy or providing the source of energy. The control unit may be connected to one or more meter(s) or sensor(s) 17, 18, 19 monitoring the aqueous solution which is treated by the external energy, as disclosed herein. The device may contain one or more temperature adjusting means, such as cooling means arranged to cool the aqueous solution in the reactor and/or heating means arranged to heat the aqueous solution in the reactor. The temperature adjusting means may be operatively connected to one or more controlling means and/or control unit(s). The controlling means may be arranged to control the temperature adjusting means, preferably as a feedback to temperature measured from the aqueous solution, to maintain the temperature of the aqueous solution in a predetermined range. FIG. 2 shows an embodiment comprising a first source of energy which is electric current provided by electrodes 20 and a second source of energy 22 which may be for example ultrasound. The other parts and functionalities may be the same as explained for FIG. 1.

The reactor or other container may be arranged to receive the leaching agent precursor. The system may contain two or more reactors, which may be connected to each other via tube(s), valve(s) and/or pump(s), and which reactors may be isolated from each other and/or connected to each other by operating the valves to close and/or open flow between reactors. A reactor may comprise an input (inlet) and/or an output (outlet). The input may be used for inputting the aqueous solution, which may be any of the aqueous solution disclosed herein, and/or for inputting the material to be treated or one or more reagent(s) or other agent(s), or water. The reactor may contain one or more input(s). It is also possible to introduce material from the top of the reactor, especially if it is open and/or if it can be opened. The reactor may contain one or more output(s). The output(s) may be used for outputting used leaching solution and/or treated material. The output(s) and/or input(s) may be at any location of the reactor, and they may include one or more aperture(s), tube(s), valve(s), which may be opened and/or closed and preferably controlled by using one or more actuator(s) connected to one or more control unit(s) or controlling means. The output 15 may be at the bottom of the reactor, such as shown in FIG. 1. The reactor may be open or it may be sealable or equipped with a lid, a cover or other means for closing and/or sealing the reactor.

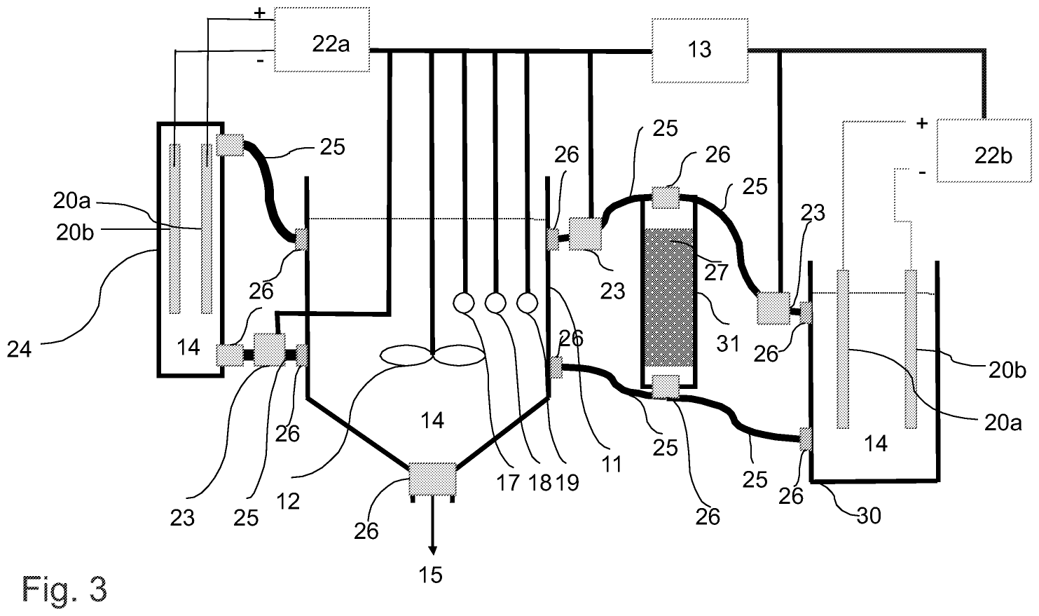

The device may contain two or more reactors, which may be connected to each other via tube(s), valve(s) and/or pump(s), and may be isolated from each other and/or connected to each other by operating the valves to close and/or open flow between reactors. An example of a such setup is presented in FIG. 3, which includes four reactors, which may be isolated from each other. Features presented in FIG. 4 can be isolated and combined with other features disclosed herein, for example one or more reactor(s) can be omitted and/or replaced with different reactor(s) or parts, or different recovery reactor or the like may be used instead. Different source(s) of external energy may be used or further included.

The reactor and/or other container(s), tubes and other applicable parts may be made of materials, such as metal, which tolerates the conditions in the reaction, such as stainless and/or acid-proof steel, or materials such as glass. Any seals and the like, optionally also tubes, may be made of other materials which tolerate said conditions, such as plastic, silicone, rubber or other suitable materials.

The device may comprise a control unit operatively connected to the one or more source(s) of external energy and to the measuring device, the control unit being, as a feedback to the measurement, arranged to adjust the one or more source(s) of external energy to obtain a desired level of reactions, such as the oxygen reduction reactions, in the aqueous solution. Adjusting the one or more source(s) of external energy may refer to setting a level of energy, such as voltage and/or current, switching the power source on and/or off, providing the power as pulses, preferably pulses of desired amplitude and/or frequency. The adjustment results in providing a desired level of energy, onset, offset, pulsing or the like adjustment of energy to the aqueous solution. The measured value may be compared to a predetermined range(s) of level(s) of reaction product(s) having a lower limit value and an upper limit value. For example if the measured level of reaction product(s) is/are lower than a predetermined lower limit(s), the level of energy may be increased. On the other hand, if the measured level of reaction product(s) is/are higher than a predetermined upper limit(s), the level of energy may be decreased. Such adjusting action(s) have an impact to the level of reactions obtained with the energy.

The method may comprise
providing a preferred prefined or predetermined range of reaction product concentration,
comparing the measured concentration value to the preferred range,
if the measured concentration value is outside the preferred range, adjusting the level of external energy to obtain a level of reactions providing a reaction product concentration in the preferred range. The measurement(s) may be carried out at a plurality of time points, such as continuously. The level of reactions may refer to at least the level of synthesis of hydrogen peroxide, and/or it may refer to a level of synthesis of leaching agent.

The device may contain one or more electrode(s), such as one or more pairs of electrodes. The electrode(s) may be connected or arranged to be connected to a power source. The power source may be operatively connected to a control unit, so that the power supply to the system may be controlled. The electrode(s) may be movable, so that they may be moved to a desired location in a reactor or the like, for example the electrode(s) may be immersed into a reaction solution and/or lifted from the reaction solution. The electrode(s) may comprise any of the electrode(s) disclosed herein, or a combination thereof.

The device may comprise
a reactor 11 arranged to receive metal-containing material and aqueous solution,
one or more non-metallic electrode(s) 20 connected or arranged to be connected to a source of electric current, the electrode(s) arranged to provide electric current to the aqueous solution 14 in the reactor 11, preferably to obtain electrochemical oxygen reduction reaction to form hydrogen peroxide,
a measuring device 17 arranged to measure one or more reaction product(s) obtained to the aqueous solution by using the external energy,
a control unit 13 operatively connected or arranged to be connected to the source of electric current and to the measuring device 17, the control unit 13 being, as a feedback to the measurement, arranged to adjust the source of electric current to obtain a desired level of reactions, such as the electrochemical oxygen reduction reactions, in the aqueous solution, and preferably
means for recovering metal complexes from the solution.

The device may further comprise one or more source of ozone, such as one or more ozone generator(s), arranged to provide ozone to the aqueous solution in the reactor, i.e. to the reactor. An ozone generator may be based on UV, corona discharge, electrolysis or cold plasma technology. For example a high frequency high voltage cold plasma or cold corona discharge generator may be used, for example comprising an ozone chamber made of high quality steel and molten pure quartz crystal, wherefrom the ozone may be conducted into the solution. By the ozone provide by the ozone generator it is possible to form redox pairs (redox couples) and/or reagents capable of further oxidizing the metals or rare earth metals. The ozone source may be used to support the other methods. The source of ozone may be operatively connected to one or more controlling means and/or control unit(s).

The device may comprise one or more measuring device or means for measuring or determining one or more parameters from the reactor and/or from the aqueous solution. As feedback to the measurement, or to determined value(s) or parameter(s), the device may be arranged to adjust the reactions in the aqueous solution, for example by adjusting the one or more source(s) of external energy 10 to maintain desired level of reactions in the aqueous solution, and/or to add one or more chemical(s) to the aqueous solution, and/or to adjust mixing, flow and/or temperature of the aqueous solution. The measuring device 17 may comprise a redox meter arranged to monitor the redox potential of the aqueous solution 14 in the reactor. The redox meter or sensor may be operatively connected to one or more controlling means and/or control unit(s) 13.

The measuring device 17 may comprise an optical measuring device. The optical measuring device may be a spectral analyzer or other device arranged to detect, monitor or measure optical spectra from the aqueous solution in the reactor. For example it is possible to measure the ultrafast optical Kerr effect to measure the picosecond dynamics and THz Raman spectral densities from an aqueous solution.

The measuring device 17 may comprise a radio frequency-based measuring device. Such a measuring device may comprise means for providing radio waves, such as a transmitter, which may act at Megahertz range, for example providing pulsed radio waves. The device may comprise means for detecting radio waves, such as one or more sensor(s). One or more parameters may be arranged to be detected from the solution, such as a spectrum of radio frequencies. The measured data, such as the spectrum, may be analyzed by using an algorithm to recognize one or more substance(s) in the solution and/or determine a quantity of one or more substance(s) in the solution.

The device may also comprise a pH meter or sensor 18 arranged to monitor the pH of the aqueous solution. As feedback to the measurement the device may be arranged to adjust the pH. The pH meter or sensor may be operatively connected to one or more controlling means and/or control unit(s) 13.

The device may also comprise a conductivity meter or sensor, preferably arranged to monitor the conductivity of the aqueous solution, and/or a temperature meter or sensor 19, preferably arranged to monitor the temperature of the aqueous solution. Also these meters or sensors may be operatively connected to one or more controlling means, and as a feedback to measured value(s) the device may be arranged to adjust any of the features, parameters, devices or actuators disclosed herein to obtain or maintain a desired function of the method or the device. The meters or sensors may be fixed or they may be movable.

The measuring device(s) may operate continuously. In such way the state of the aqueous solution can be monitored in real time. All the measuring devices may be operatively connected to the control unit. In such way the control unit may, as a response to the measured parameters, in real time carry out controlling actions to adjust the conditions in the reactor, such as control the state of the one or more energy source(s) and/or control other controllable means.

The device may comprise one or more mixer(s) and/or pump(s) arranged to convey the aqueous solution into and/or from the reactor, and/or to mix the solution. A mixer may comprise one or more mechanical mixer(s), such as one or more blade(s), rotor(s), or the like coupled to one or more actuator(s) arranged to operate the mixer(s). The actuator(s) may be operatively connected to one or more controlling means and/or control unit(s).

The device may comprise one or more means for providing catalytic materials, such as a casing, a cell, or the like, which may be flow-through type. This catalytic material may be same or different from catalytic material(s) present in electrode(s). The catalytic materials disclosed herein, or combinations thereof, may be applied. The catalytic material may be applied into a reactor, preferably to a location containing reaction solution during use, and/or the catalytic material may be provided in a tube or the like location wherein a flow of the reaction solution is provided during use.

The device may comprise one or more source(s) of transferring force targetable to the metal-containing material, such as to a unit dose of the metal-containing material, wherein the transferring force is arranged to transfer the metal-containing material in the reactor and/or a transfer tube connected to the reactor. The source(s) of transferring force may be used to transfer, move or displace the material to be processed in the system. The source of the transferring force may be for example a source of pressure or vacuum, such as a pressure tank, a compressor or a fan, a mechanical conveyor, or a source of magnetic field. In one example the system comprises a pneumatic tube system as a transferring force or system. In one example the system comprises a conveyor belt as a transferring force or system. The source(s) of transferring force may be operatively connected to one or more controlling means and/or control unit(s).

The device may comprise one or more container(s) comprising means for recovering metal connected to the reactor, wherein the treated aqueous solution is arranged to be conveyed to the container. Such a container may be arranged to be isolated from other container(s) or reactor(s), for example by closing one or more valve(s) in connecting tubes. Therefore the recovery may be carried out in a closed circuit, which may contain different solution and/or have different conditions than the other part of the system.

The device disclosed herein, which may be also called as a system, a device setup or a device arrangement, for recovering metal from waste material by leaching, may be an automated setup or system, such as semi or fully automated, and/or electronically controlled. The setup may contain one or more controlling means arranged to monitor and control the setup. The controlling means may comprise one or more control unit(s). A control unit may include one or more processors, memory, user interface, display, keyboard, power connection, one or more physical connectors for connecting to external computerized devices, and/or optionally network connection, such as wired or wireless connection. The control unit may contain or may be equipped with a software configured to carry out one or more controlling actions or a software operative, when run in the control unit, to operate the device or the system to carry out more or more controlling actions, such as to control one or more of the devices connected to the control unit. The control unit may comprise PID (Proportional, Integral and Derivative) and/or PLC controller. A PLC is s general purpose controller, which is suitable for mechanized automation. PID may be a form of closed-loop control. PID controllers is suitable for example for temperature control. A PID loop can be implemented on a PLC.

The control unit may be connected to means for controlling and/or monitoring the one or more source(s) of external energy, such as ultrasound generator(s), plasma source, corona source, and/or one or more ozone generator(s), one or more redox meter(s), one or more sensor(s) such as one or more pH meter(s), one or more temperature sensor(s), one or more pressure sensor(s), one or more optical sensor(s), one or more radio frequency sensor(s) and/or the like, one or more mixer(s), one or more pump(s), one or more valve(s), one or more device(s) for providing one or more chemical(s) to the reactor and/or to the second container, one or more means for adjusting temperature, such as heater(s) or cooler(s), one or more actuator(s), and/or one or more means for recovering metal complexes, or other device(s). The control unit may be connected or connectable to a power supply, or it may include a power supply, such as DC power supply. The power supply may be arranged to provide the external energy. The control unit may be arranged to control the level of energy provided from the power supply, for example to control the level of electric current, for example voltage and/or current. The voltage may be adjusted for example in the range of 0-250 V, such as 0-100 V, 0-50 V, 0-20 V or 0-10 V. The power supply may comprise power supply mains.

The control unit may be arranged to control said devices as a feedback to one or more detected and/or measured value(s) to maintain the temperature, oxygen content, pH, flow speed of liquid, or chemical content at a desired level, such as at a predetermined range. The control unit(s), device(s), sensor(s) and other electronic components are connected by wiring and/or they may be wirelessly connected. The system is connected to a power source, such as a to power network, to provide power for the energy source(s), electronics, meter(s), actuators, pumps and/or the like devices and/or components. The system may be arranged to automatically carry out one or more of the methods or method steps disclosed herein.

One example provides a device for recovering metal from metal-containing material by leaching, the device comprising
at least one transfer tube arranged to receive metal-containing material, such as a unit dose of the metal-containing material,
at least one reactor arranged to receive the metal-containing material and leaching agent precursor in an aqueous solution,
at least one source of transferring force targetable to the metal-containing material, such as to the unit dose of the metal-containing material, wherein the transferring force is arranged to transfer the metal-containing material in the transfer tube, wherein
the at least one transfer tube is connected to the at least one reactor to transfer the metal-containing material via the transfer tube to the reactor,
one or more source(s) of external energy 10 arranged to provide external energy to the aqueous solution 14 in the reactor 11,
a measuring device arranged to measure one or more reaction product obtained to the aqueous solution by using the external energy,
a control unit operatively connected to the one or more sources of external energy and to measuring device, the control unit being, as a feedback to the measurement, arranged to adjust the one or more source(s) of external energy to obtain a desired level of reactions, such as the oxygen reduction reactions, in the aqueous solution, and optionally
means for recovering metal complexes from the solution.

The device may comprise one or more treatment zone, which may be in the reactor or in the tube. The treatment zone may comprise perforation, aperture(s) or one or more other permeable area(s) to allow the aqueous solution to pass. The treatment zone may be arranged to be closed and opened. The material transferred in the tube may be treated with the aqueous solution at the treatment zone. Alternatively the metal-containing material, such as the unit dose of the metal-containing material, may be transferred to the reactor from the tube. The material may be treated in the reactor, and after the treatment it may be transferred from the reactor.

The source of the transferring force may be selected from source of pressure or vacuum, such as a pressure tank, a compressor or a fan, mechanical conveyor, and a source of magnetic field. In one example the system comprises a pneumatic tube system.

The device may comprise one or more diverter(s), for example connected to the tubes, which are arranged to change the position, direction and/or the route of the material, such as material as a unit dose. The tubing may be branched in a diverter. The diverter(s) may be connected to two or more transfer tube to transfer the material to a desired transfer tube.

One example provides a method for recovering metal from metal-containing material by leaching, the method comprising
optionally providing the device described in previous,
providing leaching agent precursor in an aqueous solution,
providing a source of external energy to the aqueous solution,
treating the aqueous solution with the external energy to form reactive species, such as hydrogen peroxide,
reacting the leaching agent precursor with the reactive species, such as with the hydrogen peroxide, to form a leaching agent and to obtain a leaching solution
providing metal-containing material, such as a unit dose of the metal-containing material,
placing the metal-containing material, such as the unit dose of the metal-containing material, to the transfer tube,
subjecting the metal-containing material to the transferring force to move it to the reactor,
reacting the metal-containing material, preferably in the reactor, with the leaching solution to obtain soluble metal complexes, and
recovering the soluble metal complexes.

The metal-containing material may be provided as a unit dose, wherein the metal-containing material may be in a crushed or pulverized form. The unit dose may comprise the metal-containing material in a transfer capsule, such as a perforated transfer capsule. Alternative the unit dose comprises metal-containing material which is not in a transfer capsule. In such case the unit dose may comprise metal-containing material as a solid entity, which may be packed or bagged, for example comprising a surrounding structure, which is permeable to the aqueous solution. The surrounding structure may comprise a net, wire, thread, tape, a bag or the like bonding structure.

The method comprises recovering the metal complexes, which includes recovering the metal in any suitable form obtained from the leaching. This may comprise providing a suitable recovery method and/or material(s). At the simplest the recovery may include conveying the solubilized metal(s) from the reactor. However, it is also desired to selectively separate the metal complexes of interest, and preferably transform the metal into a useful form. The device may contain one or more means for recovering metal complexes from the solution, for example in the reactor or from the reactor. The oxygen reduction reaction and/or leaching may be carried out before recovering the formed metal complexes, or these phases or steps may be carried out simultaneously or parallel, or the phases or steps may overlap. These phases may be carried out in the same container, or they may be carried out at different container. The phases may be carried out as batch processes or as continuous processes, or both, for example the oxygen reduction reaction and/or the leaching may be carried out as continuous process(es) and the recovery may be carried out as a batch process, or vice versa.

In one embodiment the recovering of the metal complexes comprises
providing surface-treated or surface-activated scavenger material able to selectively bind the metal complex(es), such as in a form of a sheet, a bar, or powder, and/or scavenger material comprising carbon nanomaterials, such as carbon nanotubes, carbon nanofibers or carbon nanobuds, and/or scavenger material obtained by additive manufacturing, and
contacting the soluble metal complexes with the scavenger material to bind the soluble metal complexes to the scavenger material to recover the metal complexes.

In one example the device comprises
a (first) reactor 11, such as a flow-through reactor or flow reactor, arranged to receive metal-containing material and aqueous solution,
one or more source(s) of external energy 10 arranged to provide external energy to the aqueous solution 14 in the reactor 11, the source of external energy comprising one or more non-metallic electrode(s) 20 connected or arranged to be connected to a source of electric current, for example wherein the electrodes are arranged in a flow-through casing or a flow-through cell,
a measuring device 17 arranged to measure one or more reaction product(s) obtained to the aqueous solution by using the external energy,
a control unit 13 operatively connected to the one or more sources of external energy and to the measuring device, the control unit 13 being, as a feedback to the measurement, arranged to adjust the one or more source(s) of external energy to obtain a desired level of reactions, such as the electrochemical oxygen reduction reactions, in the aqueous solution.

The device may comprise, be connected to or be connectable to, means for recovering metal complexes from the solution from a flow from the reactor or in the reactor. The device may comprise one or more pump(s) operatively connected to the control unit and arranged to provide flow of the aqueous solution through the flow-through reactor and/or through a casing or cell containing the electrodes and/or the means for recovering metal complexes. The means for recovering metal complexes may comprise one or more set(s) of scavenger material, preferably arranged in a flow-through casing or a flow-through cell, which sets may be similar or different, for example each one may be specific for one type of metal or metal complex.

The means for recovering metal complexes may be located in the reactor and/or outside the reactor. The means for recovering metal complexes may be in a second reactor or container, which may be connected to the first reactor for example by one or more tube(s), pipe(s), outlet(s) or the like, or the means for recovering metal complexes may be in such a tube, pipe or outlet. The first reactor may be separated from the external parts, which may include the means for recovering metal complexes, with one or more valve(s) or the like means, which may be operatively connected to the control unit. In this way it is possible to separate the leaching reaction from the recovery, so that these may be carried out separately, each as a batch process or continuously, for different periods of time, at different temperatures, at a suitable time to obtain a measured content of one or more substance(s) in a reaction solution and so on. For example the leaching may be carried out until a desired level of leaching is obtained and/or for a predetermined time, preferably by circulating the leaching solution in the reactor, and thereafter the obtained pregnant solution may be conveyed to recovery. Similarly the scavenger material may be separated from the leaching reaction/reactor and the solution may be circulated through the scavenger material until a desired degree of recovery of one or more metal(s) of interest is obtained.

The scavenger material may be arranged in one or more removable sets(s), such as a cartridge, cassette, module or the like, which may be removed from the system or device and transferred to another step, such as to elution or other removal of the bound metals or metal complexes. Alternatively the bound metals or metal complexes may be eluted or otherwise removed from the scavenger materials located in the system or device, preferably after the recovery (second) reactor or the like has been separated from the first reactor, for example by using one or more valve(s) or otherwise closing the liquid communication to the first reactor. For example the liquid in the second reactor may be exchanged, so that the leaching solution is removed and replaced with eluting solution, preferably with a washing step inbetween. The metal(s) may be finally recovered from an eluting solution.

FIG. 3 presents an example of a system setup arranged to carry out the method. A reactor 11 is equipped with a redox meter 17, a pH meter 18 and a temperature meter 19 each operatively connected to a control unit 13 for monitoring the liquid 14 in the reactor, usually an aqueous solution. The reactor also includes a mixer 12 for mixing the liquid in the reactor, and an outlet 15, which may be used for emptying the reactor and which is also equipped with controllable valve. This reactor 11 may be arranged to receive the metal-containing material.

A flow reactor 24 is connected to the first reactor 11 with tubes 25 and lead-through valves 26 and equipped with electrodes 20a, 20b connected to a first power source 22a, which is controlled by the control unit 13. The liquid 14 is pumped with a pump 23 from the first reactor 11 to the second reactor 24 and back to the first reactor so that the reactive species formed in the second reactor can be conveyed to the first rector 11. The pump 24 and valves 26 are operatively connected to the control unit. The valves include an actuator for operating the valves by the control unit.

The system includes a third reactor 30 equipped with electrodes 20a, 20b connected to a second power source 22b, which is controlled by the control unit 13. The third reactor 30 may be used for electrowinning. The third reactor 30 is connected to the first reactor 11 with tubes 25 and lead-through valves 26. The liquid 14 can be pumped with a pump 23 from the first reactor 11 to the third reactor 24. Between the first reactor 11 and the third reactor 30 there is a fourth reactor 31, which is a flow-through reactor or a flow-through cell or casing, containing porous scavenger material 27. The pregnant liquid from the first reactor 11 is arranged to be pumped through the scavenger material 27 in the flow-through reactor 31 so that the metal complexes in the pregnant solution can be bound to the scavenger material. The scavenger material can be for example removed from the casing of the reactor 31 and transferred to a further processing, or the metals can be eluted from the scavenger material by isolating the flow of the reactor 31 by closing corresponding valves and providing eluting solution. The recover of the metals may include electrowinning, so that the reactors 30 and 31 can be isolated from the other system by closing valves and the electrowinning may be carried out in the isolated circuit. All the valves or other controllable parts may be operatively connected to a control unit 13 even though the connection to the control unit is not shown in FIG. 3.

### EXAMPLES

### Example 1

Enhancing electrosynthesis effect for leaching solution activation by using special catalysts electrode materials such as surface treated/doped carbon materials by means of achieving higher redox potential of the leaching agent in acidic condition

KI 20-50 g/I was used as main leaching agent precursor and citric acid was used for adjusting the pH for achieving acidic condition between 2-4. Conductivity of the solution was adjusted by using NaCl as an electrolyte to enable usage of electrosynthesis as an activation method. Adjustment of redox potential was achieved using redox meter and control unit comprising PLC controller to maintain redox value of the solution within the levels of capable of leaching precious metals, such as from Au-coated electronic scrap components.

Aqueous mixture was prepared in laboratory scale glass reactor and electrode catalyst carbon nanomaterial was selected for providing optimal result of enhancing non-chemical electrosynthesis method to generate H₂O₂ based oxidation of potassium iodide for attaining higher redox potential preferably via two-electron ORR pathway at acidic conditions.

Aqueous solution was stirred continuously during the process by using motorized propel stirrer with rotating speed between 100-400 rpm.

Electrodes anode and cathode were placed in aqueous leaching solution and connected to DC power supply. Voltages between 0-8 VDC was applied until at minimum of more than 540 mV or preferable 600 mV or higher ORP value was achieved, and control unit was programmed to maintain the sufficient level.

It was found that redox potential increment was observed to be faster and with lesser overpotential if compared to conventional electrode materials usage such as stainless steel or the like.

Once required redox potential was achieved the gold coated material was added into solution and continuous stirring was applied. Leaching time was selected between 30 min to 3 h depending on material type, such as thickness of Au coating.

After leaching process the ionic gold was recovered by using plug flow filter scavenger. The scavenger material was obtained by applying laser surface treatment for polyamide 12 material to generate chemically active functionality capable of capturing selectively ionic gold from the solution. Surface treated PA12 was packed in flow filter and pregnant solution was passed through filter structure multiple times. Microscope was then used to visually detect that gold was attached within PA12 material.

It was found out that using surface treated polymer materials with KI based leaching solution offers much more simple way recovery method if comparing chemical precipitation where temperature and pH needs to be adjusted and altering of original pregnant solution by adding additional chemicals would make recycling of the used chemical more complex.

### Example 2

Thiourea is used as a main leaching component and same principal introduced in Example 1 is used as activation method to achieve leaching solution capable of gold and silver leaching. Thiourea of 50 g/I is added as aqueous solution and pH is adjusted with citric acid for achieving lower pH/acidic condition such as pH 0-2 or 1-4. To achieve higher electrical conductivity sodium sulfite is added as an electrolyte. Furthermore suitable balancing/stabilizing chemical to stabilize thiourea to avoid decomposition into non-reversible chemicals such as elemental sulphur can be used. Examples of a stabilizing agent include sodium phosphate and ferric sulphate. Electro synthesis of hydrogen peroxide is used to oxidate with feedback-controlled mechanism by measuring redox potential and when using optimized electrode catalyst material that enables lower potential to be used to generate H₂O₂ to function as an oxidizer. Electrosynthesis enables to minimize consumption of thiourea by using real time control of redox potential.

It was desired to avoid using metal electrodes to avoid corrosion problems and to enhance hydrogen peroxide production at low pH and lower the required potential preventing formation of harmful and non-desired side products caused by overpotential.

### Example 3

It is furthermore possible to integrate additional source or external energy, for example to the methods of Examples 1 and 2, to further enhance activation of leaching agent in parallel as follows.

Electrosynthesis of H₂O₂ using OOR pathway is carried out in the presence of ultrasound radiation, such as shown in FIG. 2, by using sono-electrochemical flow reactor with carbon-based catalyst doped or reticulated vitreous glassy carbon electrode (RVC electrode), BDD as a cathode and anode.

The electrodes are arranged in compartments in a cell. Anode and cathode compartments in a cell are separated by a cell divider membrane and leaching agent solution is pumped from reactor tank to cathodic compartment and back to reactor from anode compartment. Secondary inlet from reactor is connected to anodic compartment. The effect of activation is controlled by variables such as pH, volumetric flow, potential and ultrasonic horn amplitude 1-3 kW, frequency 20 KHz, pulse mode and distance of the horn from the electrode. It was found that powerful ultrasound increases current efficiency and cumulative concentration of H₂O₂ to oxidize metal leaching solvent into required redox potential.

### Example 4

Similarly as presented in Examples 1 and 2 the activation of the aqueous leaching agent mixture in a reactor is activated to form metal leaching solution by using carbon nanotube membrane stack or multiple stacks arrangement for flow through reactor structure. The perforated titanium plate is pressed into the CNT filter as anode or cathode and stack is packed into filtration case. Suitable DC voltage is applied for electrodes and Influent solution is pumped through the pump and could be aerated by O₂.

### Example 5

Recovering metals from epoxy, plastic, glass fiber packed or coated electronic scrap components such as plastic IC chips, transistors etc or copper from multilayer glass fibre PCB boards is carried out by using the electrochemical production of H₂O₂ and supercritical CO₂ as leaching solution. Furthermore pH adjustment of the solution is done by using organic acids such as citric acid or glacial acetic acid.

In this example all the plastic, polymer, glass fibre, epoxy coating was first pretreated and then leached in pressurized and temperature-controlled reactor where electrosynthesis based catalyst electrodes were integrated and optionally also ultrasound was applied to enhance the optimal H₂O₂ production.

Before adding plastic IC chips or PCB laminates into treatment, laminates are pretreated by placing in benzyl alcohol at 200° C. for 1-4 hours. Pretreatment of material assist physical swelling of the composites without removal of fibers embedded in the component casing or PCB laminate.

After optional pretreatment the scrap electronic components such as plastic IC or depopulated and shredded PCB boards are placed in pressure reactor and CO₂, H₂O, other supporting chemicals such as pH control such as citric acid or glacial acetic acid and electrical conductivity chemicals are added. Pressure and temperature are adjusted for CO₂ to achieve near supercritical or supercritical state. DC voltage is applied to catalyst electrodes and optionally ultrasound power is used to enhance the process efficiency.

After completion of leaching then the composites package or coatings are separated from metals and further leaching steps can be applied for separating different metals from each other.

### Example 6

A fly ash metal leaching process is applied similarly by following example 5 application guidelines without a pretreatment process step. The fly ash may be provided as pretreated wherein non-desired metals are removed or the amount thereof are reduced with other methods than leaching. 3D ionic metal catching scavengers are utilized for recovering metals from pregnant solution.

1. A method for recovering metal from metal-containing material by leaching, the method comprising:
providing aqueous solution containing leaching agent precursor,
providing one or more source(s) of external energy comprising a source of electric current connected to one or more non-metallic electrode(s) comprising carbon material(s) and/or derivatives thereof selected from graphite, graphene and carbon nanomaterial(s) selected from carbon nanofibers, carbon nanotubes and carbon nanobuds,
treating the aqueous solution with the external energy, which is electric current providing electrochemical reactions,
to form hydrogen peroxide from oxygen in the aqueous solution,
reacting the leaching agent precursor with the formed hydrogen peroxide to form a leaching agent and to obtain a leaching solution,
providing metal-containing material,
reacting the metal-containing material with the leaching solution to obtain soluble metal complexes, and
recovering the soluble metal complexes.

2. The method of claim 1, wherein the source of external energy further comprises one or more source(s) of ultrasound, one or more source(s) of laser, one or more fuel cell(s), one or more source(s) of glow-discharge electrolysis and/or one or more source(s) of contact glow discharge electrolysis, and/or means for providing the energy to the aqueous solution.

3. The method of claim 1, wherein the recovering of the metal complexes comprises
providing surface-treated or surface-activated scavenger material able to selectively bind the metal complex(es), and/or scavenger material comprising carbon nanomaterials selected from carbon nanotubes, carbon nanofibers and carbon nanobuds, and/or scavenger material obtained by additive manufacturing, and
contacting the soluble metal complexes with the scavenger material to bind the soluble metal complexes to the scavenger material to recover the metal complexes.

4. The method of claim 1, wherein the one or more non-metallic electrode(s) comprise electrode(s) comprising oriented pyrolytic graphite (HOPG), pyrolytic graphite (PG), graphite powder, porous graphite, natural graphite, doped graphene, glassy carbon (GC), pyrolytic carbon, active carbon, carbon black or carbon single crystals, or π-conjugated polymers.

5. The method of claim 1, wherein the one or more non-metallic electrode(s) comprise one or more surface-treated or surface-activated electrode(s), and/or one or more electrode(s) doped with metal-based agents or catalysts, or an electrode including or doped with non-metallic agents or catalysts selected from quinones, carbon nanotubes, mesoporous carbon, doped carbon selected from N-doped carbon, N-doped carbon nanotubes and N-doped graphite, boron-doped diamond, azobenzene, and/or nitrogen.

6. The method of claim 1, comprising providing one or more catalyst(s) selected from molybdenum, graphite, graphene and graphene-based catalyst(s), carbon fibers, carbon nanomaterials selected from carbon nanofibers, carbon nanotubes and carbon nanobuds, carbon black, such as functionalized carbon black ruthenium and complexes thereof, platinum, titanium, ScCl₃, and π-conjugated polymers immobilized on an electrode and/or as separate material from the electrodes immobilized or packed in a flow-through cell or the like casing, or deposited or immobilized onto a surface.

7. The method of claim 1, wherein the leaching agent precursor is selected from one or more of thiourea and halides and from supercritical carbon dioxide.

8. The method of claim 1, comprising measuring the level of the leaching agent in the aqueous solution, and as a feedback to the measured level, if necessary, adjusting the one or more source(s) of external energy to obtain a desired level of reactions, to maintain the formation and/or amount of the leaching agent at a predetermined range.

9. A device for recovering metal from metal-containing material by leaching, the device comprising
a reactor (11) arranged to receive metal-containing material and aqueous solution,
one or more source(s) of external energy (10) arranged to provide external energy to the aqueous solution (14) in the reactor (11), the source of external energy comprising one or more non-metallic electrode(s) (20) comprising carbon material(s) and/or derivatives thereof selected from graphite, graphene and carbon nanomaterial(s) selected from carbon nanofibers, carbon nanotubes and carbon nanobuds, connected or arranged to be connected to a source of electric current to provide electrochemical reactions to form hydrogen peroxide,
a measuring device arranged to measure one or more reaction product(s) obtained to the aqueous solution by using the external energy,
a control unit operatively connected to the one or more sources of external energy and to the measuring device, the control unit being, as a feedback to the measurement, arranged to adjust the one or more source(s) of external energy to obtain a desired level of reactions in the aqueous solution.

10. The device of claim 9, wherein the one or more non-metallic electrode(s) comprise electrode(s) comprising oriented pyrolytic graphite (HOPG), pyrolytic graphite (PG), graphite powder, porous graphite, natural graphite, doped graphene, glassy carbon (GC), pyrolytic carbon, active carbon, carbon black or carbon single crystals, or π-conjugated polymers.

11. The device of claim 9, wherein the one or more non-metallic electrode(s) comprises one or more surface-treated or surface-activated electrode(s), and/or one or more electrode(s) doped with metal-based agents or catalysts selected from Co(II) macrocycle complex(es), manganese dioxide, copper-nickel alloy(s), cobaloxime complex(es), transition metal phtalocyanine(s), and nanoparticles of Fe₂O₃ or CO₃O₄, or an electrode including or doped with non-metallic agents or catalysts such as quinones, carbon nanotubes, mesoporous carbon, doped carbon and/or nitrogen.

12. The device of claim 9, wherein the source of external energy further comprises one or more source(s) of ultrasound, one or more source(s) of laser, one or more fuel cell(s), one or more source(s) of glow-discharge electrolysis and/or one or more source(s) of contact glow discharge electrolysis, and/or means for providing the energy to the aqueous solution.

13. The device of claim 9, wherein the measuring device is selected from a redox meter arranged to monitor the redox potential of the aqueous solution in the reactor, an optical measuring device and a radio frequency based measuring device.

14. The device of claim 20, wherein the means for recovering metal complexes from the solution comprises surface-treated or surface-activated scavenger material able to selectively bind the metal complex(es).

15. The device of claim 14, wherein the means for recovering metal complexes from the solution comprises scavenger material comprising carbon nanomaterials selected from carbon nanotubes, carbon nanofibers and carbon nanobuds.

16. The device of claim 14, wherein the means for recovering metal complexes from the solution comprises scavenger material comprising or consisting of thermoplastic polymer obtained by additive manufacturing.

17. The method of claim 1, wherein the forming of hydrogen peroxide from oxygen in the aqueous solution is by electrochemical oxygen reduction.

18. The device of claim 9, wherein the electrochemical reactions are electrochemical oxygen reduction reactions.

19. The device of claim 9, comprising one or more catalyst(s) selected from molybdenum, graphite, graphene and graphene-based catalyst(s), carbon fibers, carbon nanomaterials selected from carbon nanofibers, carbon nanotubes and carbon nanobuds, carbon black, ruthenium and complexes thereof, platinum, titanium, ScCl₃, and π-conjugated polymers immobilized on an electrode and/or as separate material from the electrodes immobilized or packed in a flow-through cell or the like casing, or deposited or immobilized onto a surface.

20. The device of claim 9, comprising means for recovering metal complexes from the solution.
